(19) United States
(12) Patent Application Publication
(10) Pub. No.: US 2024/0353232 A1
(43) Pub. Date: Oct. 24, 2024

(54) INFORMATION PROCESSING SYSTEM, CONTROL METHOD, AND STORAGE MEDIUM

(71) Applicant: CANON KABUSHIKI KAISHA, Tokyo (JP)

(72) Inventors: YASUHIRO KOJIMA, Tokyo (JP); YOHEI SATO, Kanagawa (JP)

(21) Appl. No.: 18/758,443

(22) Filed: Jun. 28, 2024

Related U.S. Application Data
(63) Continuation-in-part of application No. PCT/JP2023/002205, filed on Jan. 25, 2023.

(30) Foreign Application Priority Data
Feb. 1, 2022 (JP) 2022-014166
Jul. 6, 2022 (JP) 2022-109019
Dec. 15, 2022 (JP) 2022-200058

(51) Int. Cl. G01C 21/34

(52) U.S. Cl. CPC G01C 21/3415; G01C 21/343; G01C 21/3492

(57) ABSTRACT

An information processing system that is capable of storing movement routes of a plurality of moving bodies includes a formatting unit configured to give a unique identifier to a space in three dimensions defined by, for example, prescribed criteria such as latitude/longitude/height, and format and store space information regarding a state of an object present in the space and time in association with the unique identifier, in which the formatting unit formats and stores movement route information of each of a plurality of moving bodies in association with the unique identifier.

### BACKGROUND OF THE INVENTION

### Field

The present invention relates to an information processing system regarding a three-dimensional space, a control method, a storage medium, and the like.

### Description of the Related Art

In recent years, with technological innovations such as an autonomous traveling mobility or a space recognition system in the world, the development of an overall view (hereinafter, referred to as a digital architecture) linking pieces of data or systems among constituent members of different organizations or companies has been promoted.

For example, in Japanese Patent Laid Open No. 2014-002519, a single processor divides a spatiotemporal area in time and space according to spatiotemporal management data provided by a user to generate a plurality of spatiotemporal divided areas. The processor assigns, in consideration of the temporal and spatial proximity of the spatiotemporal divided areas, identifiers for uniquely identifying the plurality of spatiotemporal divided areas, each of the identifiers being expressed by a one-dimensional integer value.

A spatiotemporal data management system in which an arrangement of time series data is determined such that pieces of spatiotemporal divided area data that are close to each other in the assigned identifiers are arranged close to each other on a storage device is disclosed.

However, in Japanese Patent Laid Open No. 2014-002519 described above, only the processor that generates the areas can ascertain data regarding the generated areas with the identifiers. Thus, a user of a different system may not utilize information of the spatiotemporal divided areas. A specific method for allowing the user of the different system to share information of the spatiotemporal divided areas is not sufficiently considered.

### SUMMARY OF THE INVENTION

An information processing system according to an aspect of the present invention includes at least one processor or circuit configured to function as: formatting unit configured to give a unique identifier to a three-dimensional space defined by prescribed criteria, and format and store space information regarding a state of an object present in the space and time in association with the unique identifier, in which the formatting unit formats and stores movement route information of each of a plurality of moving bodies in association with the unique identifier.

Further features of the present disclosure will become apparent from the following description of embodiments with reference to the attached drawings.

### BRIEF DESCRIPTION OF THE DRAWINGS

FIG. 1 is a diagram illustrating an overall configuration example of an autonomous moving body control system according to Embodiment 1 of the present invention.

FIG. 2A is a diagram illustrating an example of an input screen when the user inputs position information, and FIG. 2B is a diagram illustrating an example of a selection screen for selecting an autonomous moving body to use.

FIG. 3A is a diagram illustrating an example of a screen for confirming a current position of the autonomous moving body, and FIG. 3B is a diagram illustrating an example of a map display screen in confirming the current position of the autonomous moving body.

FIG. 4 is a functional block diagram illustrating internal configuration examples of 10 to 15 of FIG. 1.

FIG. 5A is a diagram illustrating a spatial positional relationship between an autonomous moving body 12 and a pillar 99 present as surrounding feature information in the real world, and FIG. 5B is a diagram illustrating a state in which the autonomous moving body 12 and the pillar 99 are mapped in an optional XYZ coordinate system space with P0 as an origin.

FIG. 6 is a perspective view illustrating a mechanical configuration example of the autonomous moving body 12 according to Embodiment 1.

FIG. 7 is a block diagram illustrating a specific hardware configuration example of a control unit 10-2, a control unit 11-2, a control unit 12-2, a control unit 13-2, a control unit 14-3, and a control unit 15-2.

FIG. 8 is a sequence diagram illustrating processing that is executed by the autonomous moving body control system according to Embodiment 1.

FIG. 9 is a continuation of the sequence diagram of FIG. 8.

FIG. 10 is a continuation of the sequence diagram of FIG. 9.

FIG. 11A is a diagram illustrating latitude/longitude information of the Earth, and FIG. 11B is a perspective view illustrating a prescribed space 100 of FIG. 11A.

FIG. 12 is a diagram schematically illustrating space information in the space 100.

FIG. 13A is a diagram illustrating route information displayed in map information, FIG. 13B is a diagram illustrating route information using position point cloud data displayed in map information, and FIG. 13C is a diagram illustrating route information using unique identifiers displayed in map information.

FIG. 14 is a functional block diagram illustrating connection of a conversion information storage device, a system control device, a second system control device, and the like according to Embodiment 2.

FIG. 15 is a diagram illustrating a route of an autonomous moving body 12 and a route of a second autonomous moving body 141.

FIG. 16 is a diagram illustrating an example where a second autonomous moving body route 160 is stored in a position space specified by every other unique identifier.

FIG. 17 is a sequence diagram for determining a route of the autonomous moving body 12 in a case where routes of a plurality of autonomous moving bodies are stored in a format database 14-4 of a conversion information storage device 14.

FIG. 18 is a continuation of the sequence diagram of FIG. 17.

FIG. 19A is a diagram illustrating an autonomous moving body route 150 that is an initially generated route of the autonomous moving body 12, and FIG. 19B is a diagram illustrating an autonomous moving body route 165 generated by changing the autonomous moving body route 150.

FIG. 20 is a diagram illustrating a flow of times of a certain position point on the autonomous moving body route 165.

FIG. 21 is a flowchart illustrating processing in a case where an immediate route overlaps an immediate route of another autonomous moving body.

FIG. 22 is a diagram illustrating a state in which determination is made that emergency avoidance is needed.

FIG. 23 is a diagram illustrating a state of crossing a route of a moving body having a high priority level.

FIG. 24 is a sequence diagram illustrating processing of performing emergency avoidance.

FIG. 25 is a sequence diagram in a case where the autonomous moving body 12 and the second autonomous moving body 141 perform direct communication to perform emergency avoidance.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

In the embodiments, although an example applied to control of an autonomous moving body will be described, a moving body may be configured to allow a user to operate at least one unit in relation to the movement of the moving body. That is, for example, a configuration may be made in which various kinds of display regarding a movement route or the like are performed for the user, and the user performs some of driving operations of the moving body with reference to the display.

### Embodiment 1

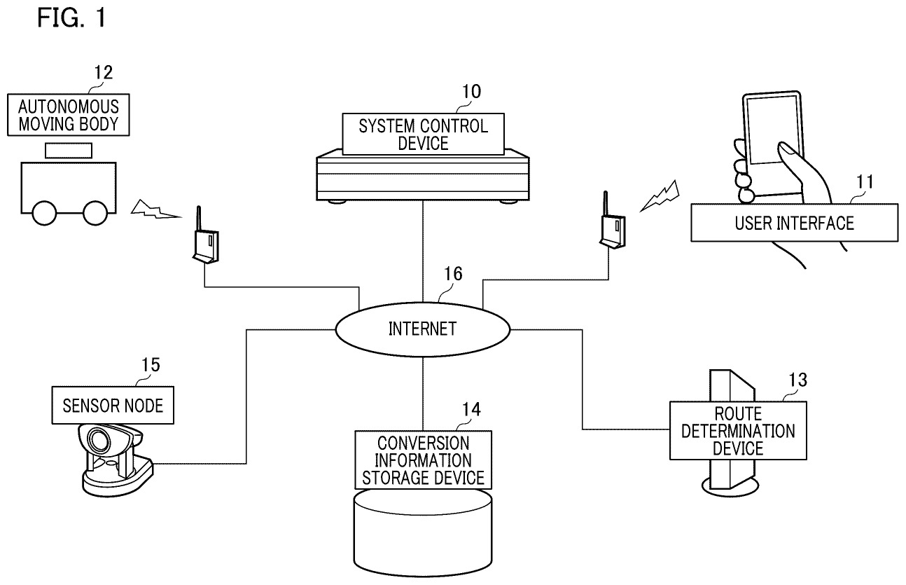

FIG. 1 is a diagram illustrating an overall configuration example of an autonomous moving body control system according to Embodiment 1 of the present invention. As illustrated in FIG. 1, an autonomous moving body control system (also simply referred to an information processing system) of the present embodiment includes a system control device 10, a user interface 11, an autonomous moving body 12, a route determination device 13, a conversion information storage device 14, a sensor node 15, and the like. Here, the user interface 11 means a user terminal device.

In the present embodiment, the devices illustrated in FIG. 1 are connected by respective network connection units described below via a network 16. However, for example, other network systems such as a local area network (LAN) may be used. Some of the system control device 10, the user interface 11, the route determination device 13, the conversion information storage device 14, and the like may be configured as the same device.

The system control device 10, the user interface 11, the autonomous moving body 12, the route determination device 13, the conversion information storage device 14, and the sensor node 15 each include an information processing device including a CPU serving as a computer, and a ROM, a RAM, and an HDD serving as a storage medium. Details of the functions and the internal configuration of each device will be described below.

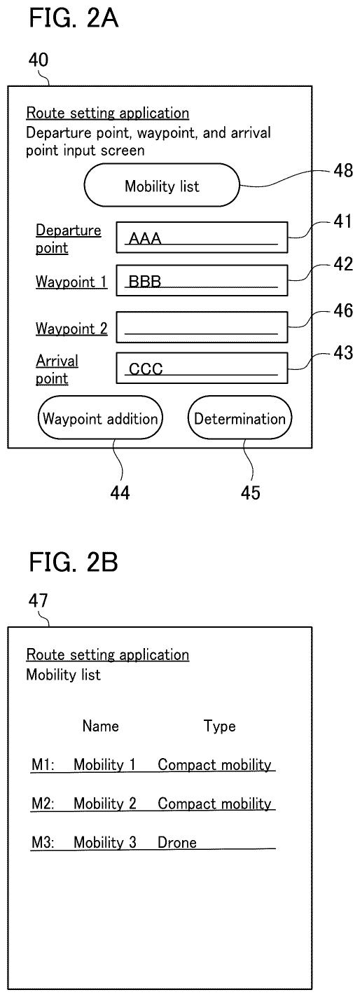

Next, service application software (hereinafter, simply referred to as an application) that is provided by the autonomous moving body control system will be described. In the description, first, a screen image that is displayed on the user interface 11 when the user inputs position information will be described with reference to FIGS. 2A and 2B.

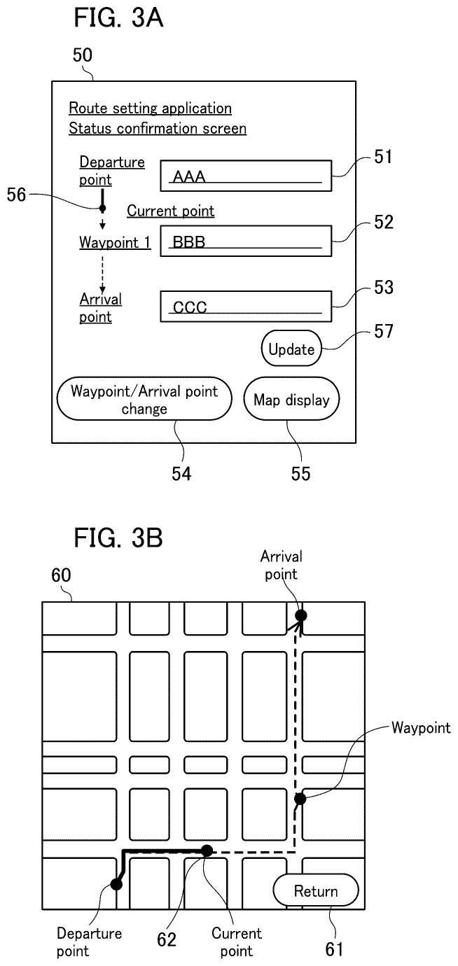

Subsequently, a screen image that is displayed on the user interface 11 when the user views a current position of the autonomous moving body 12 will be described with reference to FIGS. 3A and 3B. Through the descriptions, how the application is operated in the autonomous moving body control system will be described using an example.

In the present description, for convenience, map display will be described in a two-dimensional plane; however, in the present embodiment, the user can designate a three-dimensional position including “height” and also input “height” information. That is, according to the present embodiment, a three-dimensional map can be generated.

FIG. 2A is a diagram illustrating an example of an input screen when the user inputs position information, and FIG. 2B is a diagram illustrating an example of a selection screen for selecting an autonomous moving body to use. If the user operates a display screen of the user interface 11 to access the Internet 16 and selects, for example, a route setting application of the autonomous moving body control system, a WEB page of the system control device 10 is displayed.

First displayed on the WEB page is an input screen 40 of a departure point, a waypoint, and an arrival point for setting a departure point, a waypoint, and an arrival point in moving the autonomous moving body 12. The input screen 40 has a list display button 48 for displaying a list of autonomous moving bodies (mobilities) to use, and if the user presses the list display button 48, a list display screen 47 of mobilities is displayed as illustrated in FIG. 2B.

The user first selects an autonomous moving body (mobility) to use, on the list display screen 47. For example, mobilities indicated by M1 to M3 are selectively displayed on the list display screen 47, but the number of autonomous moving bodies is not limited thereto.

If the user selects one of the mobilities indicated by M1 to M3 by a click operation or the like, the display screen automatically returns to the input screen 40 of FIG. 2A. In the list display button 48, a selected mobility name is displayed. Thereafter, the user inputs a location to be set as a departure point in an input field 41 of “departure point”.

The user inputs a location to be set as a waypoint in an input field 42 of “waypoint 1”. A waypoint can be added, and if a waypoint addition button 44 is pressed once, an input field 46 of “waypoint 2” is additionally displayed, and a waypoint to be added can be input.

Each time the waypoint addition button 44 is pressed, an input field 46 such as “waypoint 3” or “waypoint 4” is additionally displayed, and a plurality of waypoints to be added can be input. The user inputs a location to be set as an arrival point in an input field 43 of “arrival point”. Though not illustrated in the drawing, if the input fields 41 to 43, 46, and the like are clicked, a keyboard or the like for inputting characters is temporarily displayed, and desired characters can be input.

Then, the user can set a movement route of the autonomous moving body 12 by pressing a determination button 45. In the example of FIG. 2, “AAA” is set as the departure point, “BBB” is set as the waypoint 1, and “CCC” is set as the arrival point. Words to be input in the input field may be, for example, an address, or position information for indicating a specific position such as latitude/longitude information, a store name, or a telephone number may be input.

FIG. 3A is a diagram illustrating an example of a screen for confirming a current position of an autonomous moving body, and FIG. 3B is a diagram illustrating an example of a map display screen when the user confirms the current position of the autonomous moving body. In FIG. 3A, reference numeral 50 denotes a confirmation screen, and the confirmation screen is displayed when the user operates an operation button (not illustrated) after the movement route of the autonomous moving body 12 is set on the screen as in FIG. 2A.

On the confirmation screen 50, the current position of the autonomous moving body 12 is displayed on the WEB page of the user interface 11 as a current point 56, for example. Accordingly, the user can easily ascertain the current position.

The user can update screen display information to display a latest state by pressing an update button 57. The user can change the departure point, the waypoint, and the arrival point by pressing a waypoint/arrival point change button 54. That is, the user can change the departure point, the waypoint, and the arrival point by inputting a location to be reset in an input field 51 of “departure point”, an input field 52 of “waypoint 1”, and an input field 53 of “arrival point”, respectively.

FIG. 3B illustrates an example of a map display screen 60 that is switched from the confirmation screen 50 if a map display button 55 of FIG. 3A is pressed. On the map display screen 60, a position of a current point 62 is displayed on a map, so that the user is able to confirm the current point of the autonomous moving body 12 more clearly. If the user presses a return button 61, the display screen can return to the confirmation screen 50 of FIG. 3A.

As above, the user can easily set a movement route for moving the autonomous moving body 12 from a prescribed location to a prescribed location by an operation of the user interface 11. Such a route setting application can also be applied to a taxi allocation service, a drone delivery service, or the like.

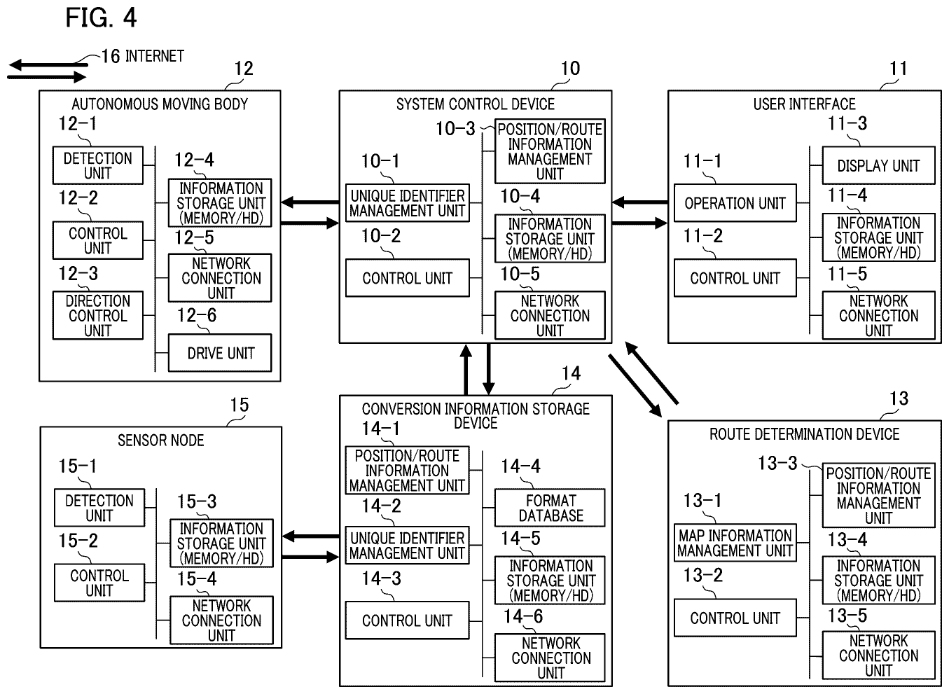

Next, configuration examples and function examples of 10 to 15 in FIG. 1 will be described in detail with reference to FIG. 4. FIG. 4 is a functional block diagram illustrating internal configuration examples of 10 to 15 of FIG. 1. Some of the functional blocks illustrated in FIG. 4 are realized by a computer (not illustrated) included in each device executing a computer program stored in a memory (not illustrated) serving as a storage medium.

However, some or all of the functional blocks may be realized by hardware. As the hardware, a dedicated circuit (ASIC), a processor (reconfigurable processor, DSP), or the like can be used.

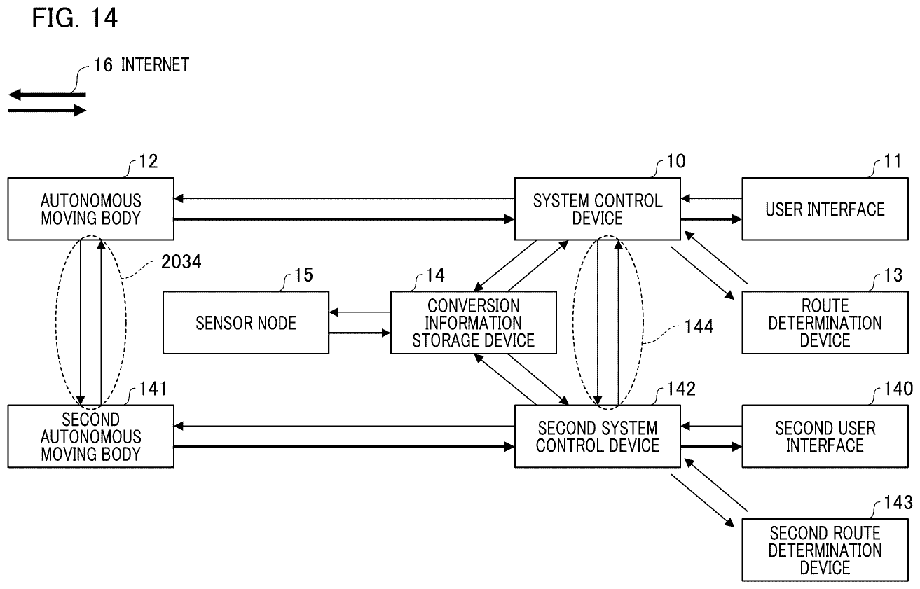

The functional blocks illustrated in FIG. 4 may not be incorporated in the same housing, and may be configured with separate devices connected via signal paths. The same applies to FIG. 14 described below.

In FIG. 4, the user interface 11 includes an operation unit 11-1, a control unit 11-2, a display unit 11-3, an information storage unit (memory/HD) 11-4, and a network connection unit 11-5.

The operation unit 11-1 is configured with a touch panel, key buttons, and the like, and is used for data input. The display unit 11-3 is, for example, a liquid crystal screen, and is used to display route information or other kinds of data.

The display screen of the user interface 11 illustrated in FIGS. 2 and 3 is displayed on the display unit 11-3. The user can perform route selection, information input, information confirmation, or the like using a menu displayed on the display unit 11-3. That is, the operation unit 11-1 and the display unit 11-3 provide an interface for operation that allows the user to actually perform an operation. Instead of separately providing the operation unit 11-1 and the display unit 11-3, a touch panel may be used as an operation unit and a display unit.

The control unit 11-2 incorporates a CPU serving as a computer, and performs management of various applications in the user interface 11 or mode management such as information input and information confirmation to control communication processing. The control unit 11-2 controls processing in each unit of the system control device.

The information storage unit (memory/HD) 11-4 is a database for keeping, for example, necessary information such as the computer program executed by the CPU. The network connection unit 11-5 controls communication that is performed via the Internet, a LAN, a wireless LAN, or the like. The user interface 11 may be, for example, a device such as a smartphone or may be in the form of a tablet terminal.

In this way, the user interface 11 of the present embodiment displays the departure point, the waypoint, the arrival point, and the like on the input screen 40 on a browser screen of the system control device 10, and the user can input position information such as the departure point, the waypoint, and the arrival point. In addition, the current position of the autonomous moving body 12 can be displayed by displaying the confirmation screen 50 and the map display screen 60 on the browser screen.

In FIG. 4, the route determination device 13 includes a map information management unit 13-1, a control unit 13-2, a position/route information management unit 13-3, an information storage unit (memory/HD) 13-4, and a network connection unit 13-5. The map information management unit 13-1 keeps wide-area map information, searches for route information indicating a route on a map based on designated prescribed position information, and transmits the route information as a search result to the position/route information management unit 13-3.

The map information is three-dimensional map information including information such as geographical features or latitude/longitude/altitude, and also includes regulation information involved in the Road Traffic Law such as roadways, sidewalks, running directions, and traffic regulations.

For example, time-varying traffic regulation information such as a one-way street depending on a time period or a pedestrian walkway depending on a time period is also included along with time information. The control unit 13-2 incorporates a CPU serving as a computer, and controls processing in each unit of the route determination device 13.

The position/route information management unit 13-3 manages position information of an autonomous moving body acquired via the network connection unit 13-5, transmits the position information to the map information management unit 13-1, and manages the route information as the search result acquired from the map information management unit 13-1. The control unit 13-2 converts the route information managed by the position/route information management unit 13-3 into a prescribed data format according to a request of an external system, and transmits the route information to the external system.

As above, in the present embodiment, the route determination device 13 is configured to search for a route conforming to the Road Traffic Law or the like based on the designated position information, and output the route information in a prescribed data format.

In FIG. 4, the conversion information storage device 14 includes a position/route information management unit 14-1, a unique identifier management unit 14-2, a control unit 14-3, a format database 14-4, an information storage unit (memory/HD) 14-5, and a network connection unit 14-6.

The conversion information storage device 14 may function as a formatting unit that gives a unique identifier to a three-dimensional space defined by latitude/longitude/height, and formats and stores space information regarding a state of an object present in the space and time in association with the unique identifier.

The position/route information management unit 14-1 manages prescribed position information acquired by way of the network connection unit 14-6, and transmits the position information to the control unit 14-3 according to a request of the control unit 14-3. The control unit 14-3 incorporates a CPU serving as a computer, and controls processing in each unit of the conversion information storage device 14.

Based on the position information acquired from the position/route information management unit 14-1 and information regarding a format managed by the format database 14-4, the control unit 14-3 converts the position information into a unique identifier specified by the format. Then, the unique identifier is transmitted to the unique identifier management unit 14-2.

While the format will be described below in detail, an identifier (hereinafter, referred to as a unique identifier) is allocated to a space with a prescribed position as a starting point, and the space is managed by the unique identifier. In the present embodiment, a corresponding unique identifier or information in the space can be acquired based on prescribed position information.

The unique identifier management unit 14-2 manages the unique identifier converted by the control unit 14-3 and transmits the unique identifier by way of the network connection unit 14-6. The format database 14-4 manages information regarding the format, and transmits information regarding the format to the control unit 14-3 according to a request of the control unit 14-3.

Information in the space acquired by way of the network connection unit 14-6 is managed using the format. The conversion information storage device 14 manages information regarding the space acquired by external equipment, devices, and networks in connection with the unique identifier. The unique identifier and information regarding the space in association with the unique identifier are provided to the external equipment, the devices, and the networks.

As above, the conversion information storage device 14 acquires the unique identifier and information in the space based on prescribed position information, and manages and provides information in a state in which information is able to be shared with the external equipment, the devices, and the networks connected thereto. The conversion information storage device 14 converts the position information designated in the system control device 10 into the unique identifier and provides the unique identifier to the system control device 10.

In FIG. 4, the system control device 10 includes a unique identifier management unit 10-1, a control unit 10-2, a position/route information management unit 10-3, an information storage unit (memory/HD) 10-4, and a network connection unit 10-5. The position/route information management unit 10-3 keeps simple map information in which correspondence between terrain information and latitude/longitude information is achieved, and manages prescribed position information and route information acquired by way of the network connection unit 10-5.

The position/route information management unit 10-3 can segment the route information at prescribed intervals and generate position information such as latitude/longitude of a segmented location. The unique identifier management unit 10-1 manages information regarding conversion of the position information and the route information into the unique identifier.

The control unit 10-2 incorporates a CPU serving as a computer, controls a communication function of the position information, the route information, and the unique identifier of the system control device 10, and controls processing in each unit of the system control device 10.

The control unit 10-2 provides the WEB page to the user interface 11, and transmits prescribed position information acquired from the WEB page to the route determination device 13. The control unit 10-2 acquires prescribed route information from the route determination device 13, and transmits each piece of position information of the route information to the conversion information storage device 14. Then, the control unit 10-2 transmits the route information converted into the unique identifier acquired from the conversion information storage device 14 to the autonomous moving body 12.

As above, the system control device 10 is configured to perform the acquisition of the prescribed position information designated by the user, the transmission and reception of the position information and the route information, the generation of the position information, and the transmission and reception of the route information using the unique identifier.

The system control device 10 collects the route information necessary for autonomous movement of the autonomous moving body 12 based on the position information input to the user interface 11, and provides the route information using the unique identifier to the autonomous moving body 12. In the present embodiment, the system control device 10, the route determination device 13, and the conversion information storage device 14 function as, for example, a server.

In FIG. 4, the autonomous moving body 12 includes a detection unit 12-1, a control unit 12-2, a direction control unit 12-3, an information storage unit (memory/HD) 12-4, a network connection unit 12-5, and a drive unit 12-6. The detection unit 12-1 has, for example, a plurality of imaging elements, and has a function of performing distance measurement based on a phase difference between a plurality of imaging signals obtained from the plurality of imaging elements.

The detection unit 12-1 has a self-position estimation function of acquiring detection information of obstacles such as surrounding terrain and building walls (hereinafter, referred to as detection information) and estimating a self-position based on the detection information and the map information.

The detection unit 12-1 has a self-position detection function such as a global positioning system (GPS) and a direction detection function such as a geomagnetic sensor. The control unit 12-2 can generate a three-dimensional map of a cyberspace based on the acquired detection information, self-position estimation information, and direction detection information.

Here, the three-dimensional map of the cyberspace can express space information equivalent to a feature position of the real world in the form of digital data. In the three-dimensional map of the cyberspace, information regarding the autonomous moving body 12 present in the real world or surrounding feature information is kept as spatially equivalent information in the form of digital data. Accordingly, efficient movement can be performed using the digital data.

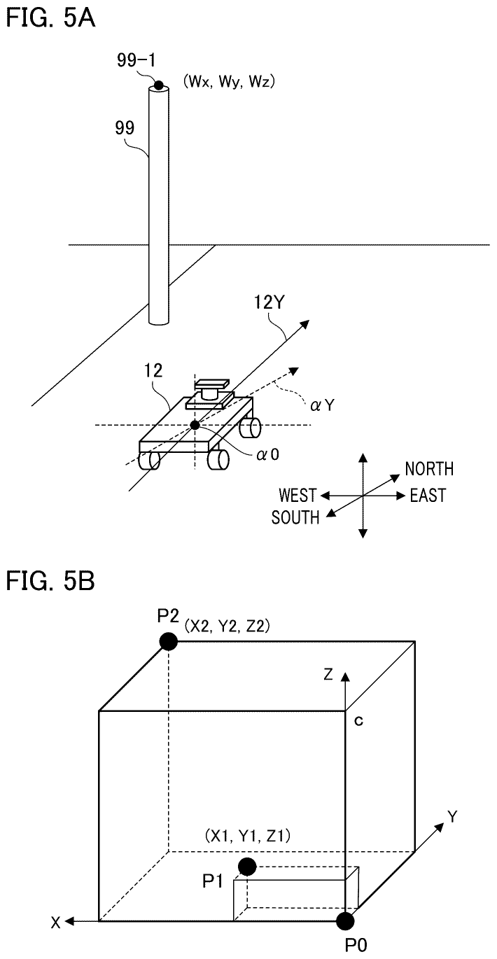

Hereinafter, a three-dimensional map of a cyberspace that is used in the present embodiment will be described with reference to FIG. 5 as an example. FIG. 5A is a diagram illustrating a spatial positional relationship between an autonomous moving body 12 and a pillar 99 present as surrounding feature information in the real world, and FIG. 5B is a diagram illustrating a state in which the autonomous moving body 12 and the pillar 99 are mapped in an optional XYZ coordinate system space with a position P0 as an origin.

In FIGS. 5A and 5B, the position of the autonomous moving body 12 is specified as a position α0 in the autonomous moving body 12 from position information of latitude and longitude acquired by a GPS (not illustrated) or the like mounted in the autonomous moving body 12. An azimuth of the autonomous moving body 12 is specified by a difference between an azimuth αY acquired by an electronic compass (not illustrated) or the like and a moving direction 12Y of the autonomous moving body 12.

The position of the pillar 99 is specified as a position of a vertex 99-1 from position information measured in advance. A distance between α0 of the autonomous moving body 12 and the vertex 99-1 can be measured by the distance measurement function of the autonomous moving body 12. In FIG. 5A, if α0 is set as an origin with the moving direction 12Y as an axis of an XYZ coordinate system, the distance is illustrated as coordinates (Wx, Wy, Wz) of the vertex 99-1.

In the three-dimensional map of the cyberspace, information acquired in this manner can be managed in the form of digital data, and can be reconfigured as space information illustrated in FIG. 5B by the system control device 10, the route determination device 13, and the like. FIG. 5B illustrates a state in which the autonomous moving body 12 and the pillar 99 are mapped in an optional XYZ coordinate system space with P0 as the origin.

The autonomous moving body 12 in the optional XYZ coordinate system space can be expressed as P1 and the pillar 99 can be expressed as P2 by setting P0 as a prescribed latitude and longitude in the real world and taking the azimuth of north in the real world in a Y-axis direction.

Specifically, the position P1 of α0 in the space can be calculated from the latitude and longitude of α0 and the latitude and longitude of P0. Similarly, the pillar 99 can be calculated as P2. In this example, while two of the autonomous moving body 12 and the pillar 99 are expressed by the three-dimensional map of the cyberspace, even a greater number of autonomous moving bodies or objects can be of course handled similarly. As above, the three-dimensional map is formed by mapping the self-position or the object of the real world in the three-dimensional space.

Returning to FIG. 4, the autonomous moving body 12 stores training result data of object detection by machine learning in, for example, the information storage unit (memory/HD) 12-4, and can perform object detection from a captured imaged using machine learning. The detection information can also be acquired from an external system by way of the network connection unit 12-5 and reflected in the three-dimensional map.

The control unit 12-2 incorporates a CPU serving as a computer, controls movement, direction change, and an autonomous traveling function of the autonomous moving body 12, and controls processing in each unit of the autonomous moving body 12.

The direction control unit 12-3 changes the moving direction of the autonomous moving body 12 by changing a direction of driving of the moving body by the drive unit 12-6. The drive unit 12-6 includes a drive device such as a motor, and generates propulsion power of the autonomous moving body 12. The autonomous moving body 12 can reflect the self-position, the detection information, and object detection information in the three-dimensional map, generate a route with a given interval from surrounding terrain, buildings, obstacles, or objects, and perform autonomous traveling.

The route determination device 13 performs route generation in consideration of regulation information mainly involved in the Road Traffic Law. On the other hand, the autonomous moving body 12 detects positions of surrounding obstacles more accurately in the route by the route determination device 13 and performs route generation for moving without coming into contact with the obstacles, based on the size of the autonomous moving body 12.

The information storage unit (memory/HD) 12-4 of the autonomous moving body 12 can also store a mobility type of the autonomous moving body. The mobility type is, for example, a classification of a moving body identified legally, and means, for example, a classification such as an automobile, a bicycle, or a drone. Based on the mobility type, format route information described below can be generated.

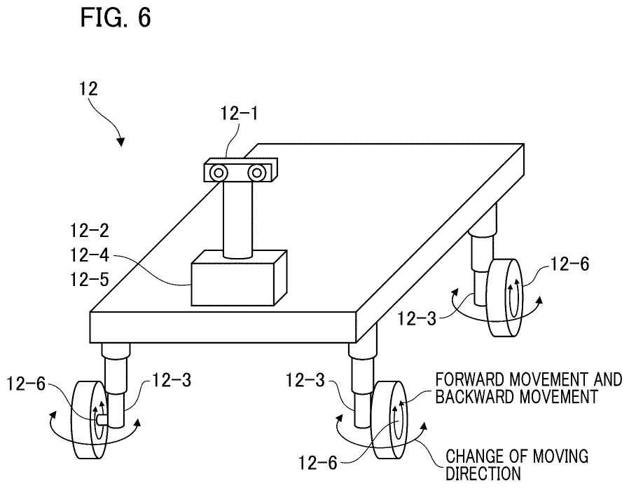

Here, a main body configuration example of the autonomous moving body 12 in the present embodiment will be described with reference to FIG. 6. FIG. 6 is a perspective view illustrating a mechanical configuration example of the autonomous moving body 12 according to Embodiment 1. In the present embodiment, while an example where the autonomous moving body 12 is a traveling body having wheels will be described, the autonomous moving body 12 is not limited to a traveling body having wheels, and may be a flying body such as a drone.

In FIG. 6, the detection unit 12-1, the control unit 12-2, the direction control unit 12-3, the information storage unit (memory/HD) 12-4, the network connection unit 12-5, and the drive unit 12-6 are mounted in the autonomous moving body 12, and the units are electrically connected. At least two drive units 12-6 and direction control units 12-3 are provided in the autonomous moving body 12.

The direction control unit 12-3 changes the moving direction of the autonomous moving body 12 by changing the direction of the drive unit 12-6 through rotational drive of a shaft, and the drive unit 12-6 performs forward movement and backward movement of the autonomous moving body 12 through rotation of the shaft. The configuration described with reference to FIG. 6 is merely an example, and the configuration of the autonomous moving body 12 is not limited thereto. For example, the moving direction may be changed using omni-wheels or the like.

The autonomous moving body 12 is a moving body using, for example, the simultaneous localization and mapping (SLAM) technique. The autonomous moving body 12 is configured to autonomously move along a designated prescribed route based on the detection information detected by the detection unit 12-1 or the like and the detection information of the external system acquired via the Internet 16.

The autonomous moving body 12 can also perform trace movement such as tracing points designated finely, and can generate route information for itself and move in a space between points set loosely while passing through the points. As above, the autonomous moving body 12 of the present embodiment can perform autonomous movement based on the route information using the unique identifier provided by the system control device 10.

Returning to FIG. 4, the sensor node 15 is an external system that is, for example, a video monitoring system such as a roadside camera unit, and includes a detection unit 15-1, a control unit 15-2, an information storage unit (memory/HD) 15-3, and a network connection unit 15-4. The detection unit 15-1 is, for example, a camera, acquires detection information of an area detectable by the detection unit 15-1, and has an object detection function and a distance measurement function.

The control unit 15-2 incorporates a CPU serving as a computer, controls the detection of the sensor node 15, data storage, and a data transmission function, and controls processing in each unit of the sensor node 15. The control unit 15-2 stores detection information acquired by the detection unit 15-1 in the information storage unit (memory/HD) 15-3 and transmits the conversion information storage device 14 by way of the network connection unit 15-4.

As above, the sensor node 15 is configured to store detection information such as image information detected by the detection unit 15-1, feature point information of detected objects, and position information in the information storage unit 15-3, and perform communication. The sensor node 15 provides the detection information of the area detectable by the sensor node 15 to the conversion information storage device 14.

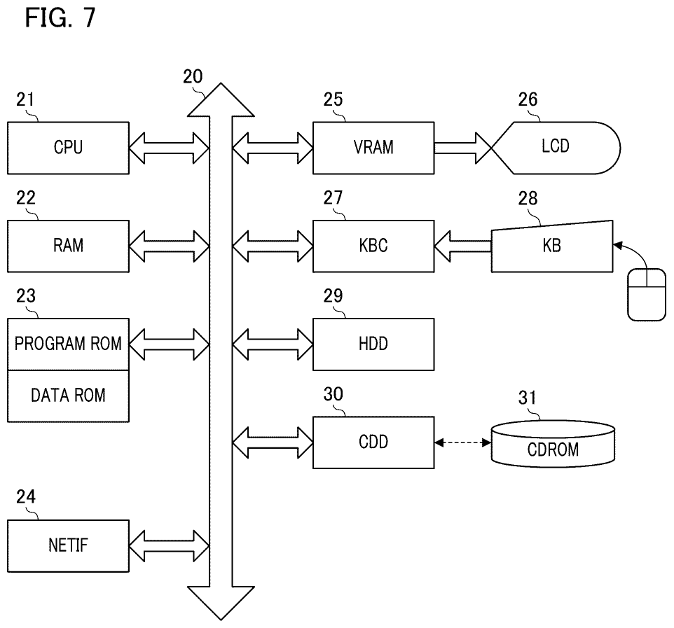

Next, a specific hardware configuration of each control unit in FIG. 4 will be described. FIG. 7 is a block diagram illustrating a specific hardware configuration example of the control unit 10-2, the control unit 11-2, the control unit 12-2, the control unit 13-2, the control unit 14-3, and the control unit 15-2. The configuration of each control unit is not limited to the hardware configuration illustrated in FIG. 7. All of the blocks illustrated in FIG. 7 may not be provided.

In FIG. 7, reference numeral 21 denotes a CPU serving as a computer that takes charge of arithmetic operation and control of the information processing device. Reference numeral 22 denotes a RAM, and the RAM functions as a main memory of the CPU 21, an execution program area, an execution area of the program, and a data area. Reference numeral 23 denotes a ROM that stores an operation processing procedure of the CPU 21.

The ROM 23 includes a program ROM that stores basic software (OS) which is a system program for performing device control of the information processing device, and a data ROM that stores information necessary for operating the system, or the like. Instead of the ROM 23, an HDD 29 described below may be used.

Reference numeral 24 denotes a network interface (NETIF), and the network interface performs control to transfer data or diagnoses a connection status between information processing devices via the Internet 16. Reference numeral 25 denotes a video RAM (VRAM), and the VRAM rasterizes an image to be displayed on a screen of an LCD 26, and controls the display. Reference numeral 26 denotes a display device (hereinafter, referred to as an LCD) such as a display.

Reference numeral 27 denotes a controller (hereinafter, referred to as a KBC) that controls an input signal from an external input device 28. Reference numeral 28 denotes an external input device (hereinafter, referred to as a KB) that receives an operation of the user, and for example, a keyboard or a pointing device such as a mouse is used.

Reference numeral 29 denotes a hard disk drive (hereinafter, referred to as an HDD), and the HDD is used to store application programs or various kinds of data. In the present embodiment, the application programs are software programs and the like that execute various processing functions in the present embodiment.

Reference numeral 30 denotes an external input/output device (hereinafter, referred to as a CDD). For example, a CDROM drive, a DVD drive, or a Blu-Ray (Registered Trademark) disk drive that inputs and outputs data to and from a removable medium 31 serving as a removable data recording medium is used.

The CDD 30 is used in reading the above-described application programs from the removable medium, or the like. Reference numeral 31 denotes a removable medium to be read by the CDD 30. The removable medium is, for example, CDROM disk, a DVD, or a Blu-Ray (Registered Trademark) disk.

The removable medium may be a magneto-optical recording medium (for example, MO), a semiconductor recording medium (for example, a memory card), or the like. The application programs or data stored in the HDD 29 can be stored in the removable medium 31 and used. Reference numeral 20 denotes a transmission bus (address bus, data bus, input/output bus, and control bus) that connects the above-described units.

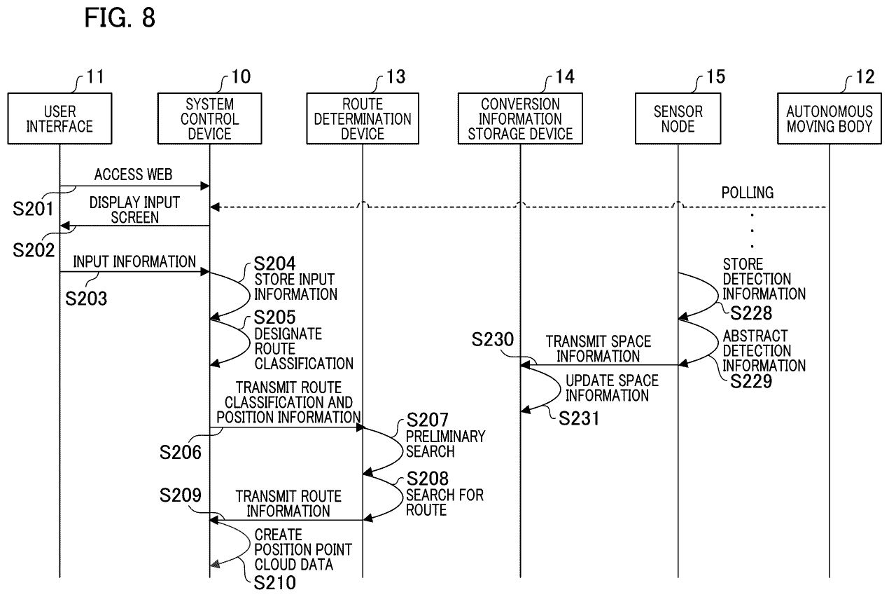

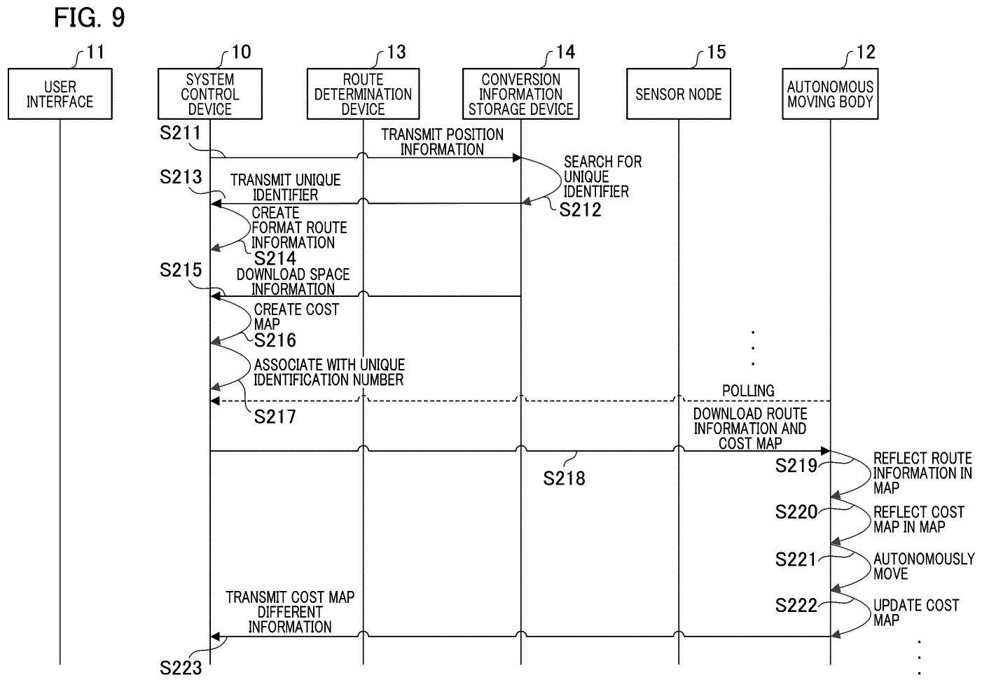

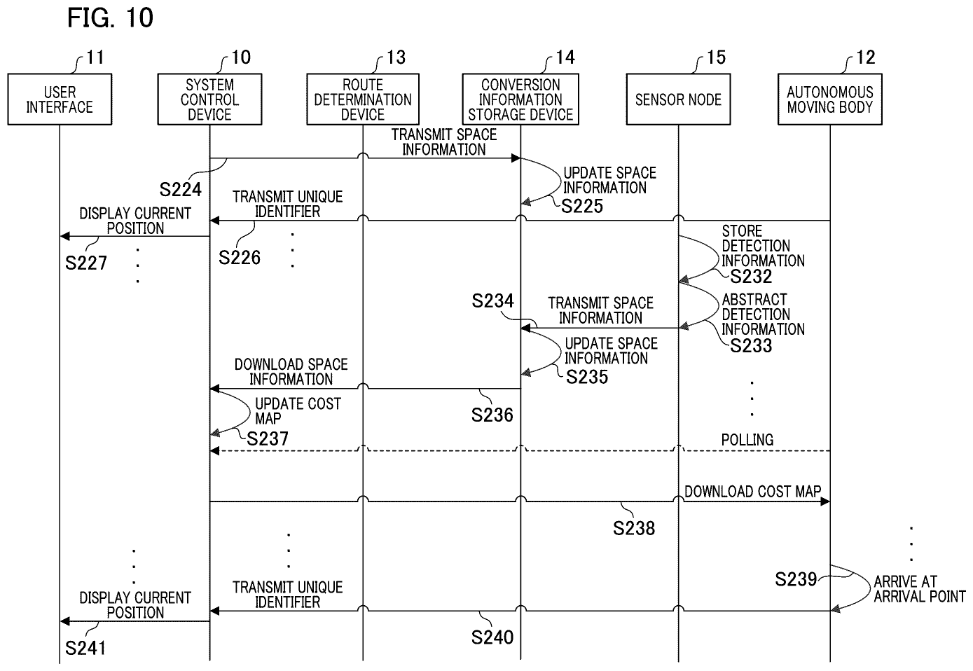

Next, details of a control operation in the autonomous moving body control system for realizing the route setting application and the like as described with reference to FIGS. 2 and 3 will be described with reference to FIGS. 8 to 10. FIG. 8 is a sequence diagram illustrating processing that is executed by the autonomous moving body control system according to Embodiment 1, FIG. 9 is a continuation of the sequence diagram of FIG. 8, and FIG. 10 is a continuation of the sequence diagram of FIG. 9.

FIGS. 8 to 10 illustrate processing that is executed by the devices until the user receives current position information of the autonomous moving body 12 after inputting the position information to the user interface 11. The operations in steps of the sequences of FIGS. 8 to 10 are performed by the computer in the control unit of 10 to 15 executing the computer program stored in the memory.

First, in Step S201, the user accesses the WEB page provided by the system control device 10 using the user interface 11. In Step S202, the system control device 10 displays the input screen as described with reference to FIG. 2 on the display screen of the WEB page. In Step S203, as described with reference to FIG. 2, the user selects an autonomous moving body (mobility) and inputs position information indicating the departure point/waypoint/arrival point (hereinafter, referred to as position information).

The position information may be, for example, a word (hereinafter, referred to as a position word) designating a specific location such as a building name, a station name, or an address, or a method of designating a specific position of the map displayed on the WEB page as a point (hereinafter, referred to as a point) may be utilized.

In Step S204, the system control device 10 stores classification information of the selected autonomous moving body 12 and input information such as the input position information. In this case, if the position information is the position word, the position word is stored, and if the position information is the point, latitude/longitude corresponding to the point is searched for based on the simple map information stored in the position/route information management unit 10-3, and the latitude/longitude is stored.

Next, in Step S205, the system control device 10 designates a classification (hereinafter, referred to as a route classification) of a movable route from the mobility type (classification) of the autonomous moving body 12 designated by the user. Then, in Step S206, the system control device 10 transmits the route classification to the route determination device 13 along with the position information.

The mobility type is a classification or the like of a moving body distinguished legally as described above, and means, for example, a classification such as an automobile, a bicycle, or a drone. The route classification is, for example, a general road, a highway, or a motorway if the moving body is an automobile, and is a prescribed sidewalk, a walkway along a general road, or a bicycle lane if the moving body is a bicycle.

In Step S207, the route determination device 13 inputs the received position information as the departure point/waypoint/arrival point to the map information held therein. If the position information is the position word, a search is performed in the map information with the position word, and corresponding latitude/longitude information is used. If the position information is the latitude/longitude information, the position information is input to the map information and used as it is. A preliminary search for a route may be performed.

Subsequently, in Step S208, the route determination device 13 searches a route from the departure point to the arrival point by way of the waypoint. In this case, in relation to the route to be searched, a route conforming to the route classification is searched for. Then, in Step S209, the route determination device 13 outputs, as a result of the search, the route (hereinafter, referred to as route information) from the departure point to the arrival point by way of the waypoint in a GPS exchange format (GPX format), and transmits the route information to the system control device 10.

The file in the GPX format is primarily composed of three kinds of a waypoint (point information having no order relationship), a route (point information having an order relationship to which time information is attached), and a track (a set of a plurality of pieces of point information: trajectory).

The latitude/longitude as an attribute value of each piece of point information, and an elevation, a geoid height, a GPS reception status or accuracy as a child element are described. A minimum element necessary for the GPX file is latitude/longitude information of a single point, and the description of other kinds of information is optional. The route is output as the route information and is a set of pieces of point information including latitude/longitude having an order relationship. The route information may have other formats as long as the above condition is satisfied.

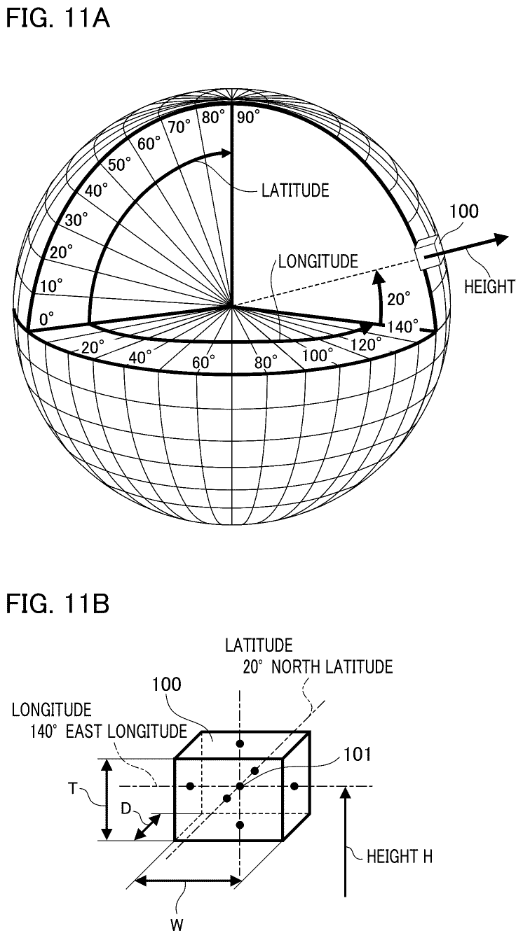

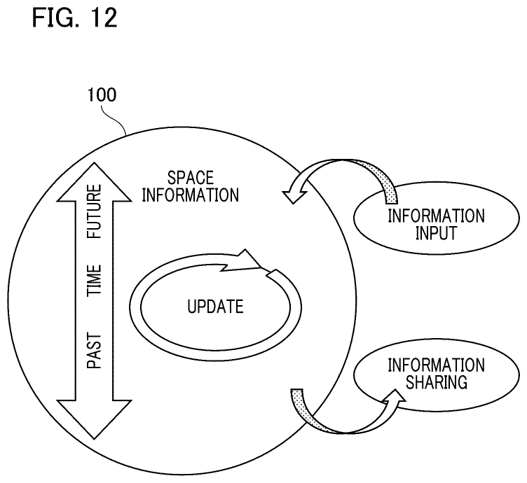

Here, a configuration example of the format managed by the format database 14-4 of the conversion information storage device 14 will be described with reference to FIGS. 11A, 11B, and 12.

FIG. 11A is a diagram illustrating latitude/longitude information of the Earth, and FIG. 11B is a perspective view illustrating a prescribed space 100 of FIG. 11A. In FIG. 11B, a center of the prescribed space 100 is referred to as a center 101. FIG. 12 is a diagram schematically illustrating space information in the space 100.

In FIGS. 11A and 11B, the format enables the management of the space of the Earth by dividing the space of the Earth into three-dimensional spaces determined according to a range with latitude/longitude/height as a starting point and attaching a unique identifier to each space. Here, for example, the space 100 is displayed as a prescribed three-dimensional space.

The space 100 is a divided space in which the center 101 is specified by 20 degrees north latitude, 140 degrees east longitude, and height (altitude, elevation) H, a width in a latitude direction is specified by D, a width in a longitude direction is specified by W, and a width in a height direction is specified by T. The space 100 is one space obtained by dividing the space of the Earth into a space determined by a range with latitude/longitude/height as a starting point.

In FIG. 11A, for convenience, while only the space 100 is displayed, in the specification of the format, it is assumed that the spaces specified in the same manner as the space 100 are disposed in parallel in the latitude/longitude/height directions as described above. Then, it is assumed that each of the disposed divided spaces is a space in which a horizontal position is defined by latitude/longitude, which also has overlap also in the height direction, and in which a position in the height direction is defined by height.

In FIG. 11B, while the center 101 of the divided space is set as the starting point of latitude/longitude/height, the starting point is not limited thereto, and for example, a corner or a center of a bottom surface of the space may be set as the starting point. A shape may be substantially a rectangular parallelepiped, and considering a case where the spaces are laid over a surface of a sphere such as the Earth, the spaces can be disposed with fewer gaps if a top surface of the rectangular parallelepiped is set to be wider than a bottom surface.

With the space 100 in FIG. 12 as an example, information (space information) regarding a classification of an object that is present in or capable of entering the range of the space 100 and a time limit is formatted and stored in the format database 14-4 in association (in connection) with a unique identifier. The formatted space information is stored in time series from past to future. In the present embodiment, the terms “association” and “connection” are used as the same meaning.

That is, the conversion information storage device 14 formats the space information regarding the classification of the object that is present in or capable of entering the three-dimensional space defined by latitude/longitude/height and the time limit in relation with the unique identifier and stores the space information in the format database 14-4.

The space information is updated at a prescribed update interval based on information supplied from an information supply unit such as an external system (for example, the sensor node 15) connected to the conversion information storage device 14 in a communicable manner. Then, information is shared by other external systems connected to the conversion information storage device 14 in a communicable manner. For an application in which information regarding time is not required, space information not including information regarding time can also be used. Instead of the unique identifier, a non-unique identifier may be used.

Information regarding a company/individual having the external system, information regarding an access method to the detection information acquired from the external system, and specification information of the detection information such as metadata/communication mode of the detection information can be managed as space information in relation with the unique identifier.

As above, in Embodiment 1, information (hereinafter, referred to as space information) regarding the classification of the object that is present in or capable of entering the three-dimensional space defined by latitude/longitude/height and the time limit is formatted in relation with the unique identifier and stored in the database. Then, time and space can be managed by the formatted space information.

In the present embodiment, while description has been provided using latitude/longitude/height as the coordinate system specifying the position of the space (voxel), the coordinate system is not limited thereto. For example, various coordinate systems such as an XYZ coordinate system having optional coordinate axes or a military grid reference system (MGRS) for use as coordinates in a horizontal direction can be used.

In addition, a pixel coordinate system in which a pixel position of an image is used as coordinates or a tile coordinate system in which a prescribed area is divided in units of tiles and the tiles are expressed in parallel in X/Y directions can also be used.

The conversion information storage device 14 of Embodiment 1 executes a formatting step of formatting and storing information regarding the update interval of the space information in relation with the unique identifier. Note that information regarding the update interval to be formatted in relation with the unique identifier may be an update frequency, and information regarding the update interval includes the update frequency.

Returning to FIG. 8, a continuation of the processing that is executed by the autonomous moving body control system will be described. In Step S210, the system control device 10 confirms an interval between the point information in the received route information. Then, the point information having the interval matching an interval between starting point positions of the divided spaces specified by the format is created as position point cloud data.

In this case, if the interval between the point information is smaller than the interval between the starting point positions of the divided spaces, the system control device 10 sets the point information after thinning out the point information in the route information in conformity with the interval between the starting point positions of the divided spaces, as position point cloud data. If the interval between the point information is greater than the interval between the starting point positions of the divided spaces, the system control device 10 sets the point information after interpolating the point information within a range without deviating from the route information, as position point cloud data.

Next, as illustrated in Step S211 of FIG. 9, the system control device 10 transmits the latitude/longitude information of each piece of point information of the position point cloud data to the conversion information storage device 14 in an order of the routes. In Step S212, the conversion information storage device 14 searches for the unique identifier corresponding to the received latitude/longitude information from the format database 14-4, and in Step S213, transmits the unique identifier to the system control device 10.

In Step S214, the system control device 10 arranges the received unique identifiers in the same order as original position point cloud data and stores the route information (hereinafter, referred to as format route information) using the unique identifiers. In this way, in Step S214, the system control device 10 serving as a route generation unit acquires the space information from the database of the conversion information storage device 14 and generates the route information regarding the movement route of the moving body based on the acquired space information and the classification information of the moving body.

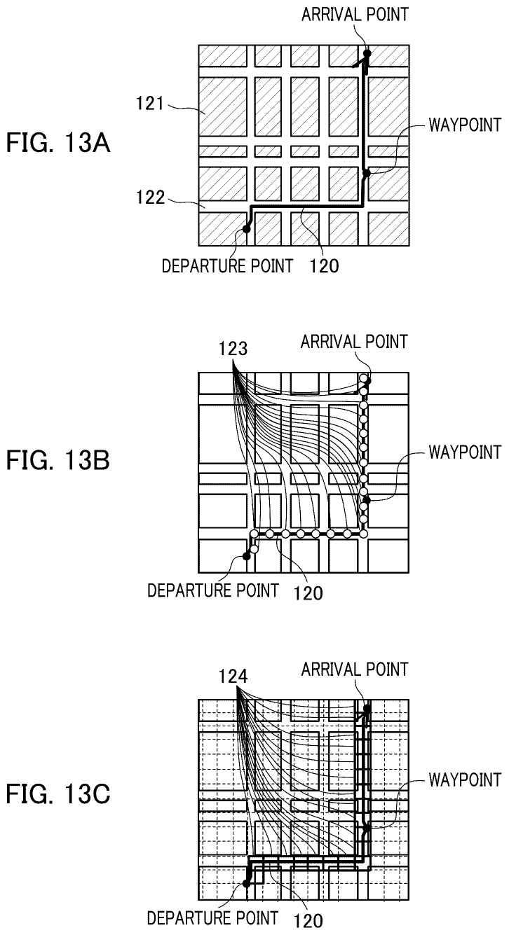

Here, a process of generating the position point cloud data from the route information and converting the route information into route information using unique identifiers will be described in detail with reference to FIGS. 13A, 13B, and 13C. FIG. 13A is an image diagram illustrating route information displayed in map information, FIG. 13B is an image diagram illustrating route information using position point cloud data displayed in map information, and FIG. 13C is an image diagram illustrating route information using unique identifiers displayed in map information.

In FIG. 13A, reference numeral 120 denotes route information, reference numeral 121 denotes a non-movable area through which the autonomous moving body 12 cannot pass, and reference numeral 122 denotes a movable area where the autonomous moving body 12 can move. The route information 120 generated by the route determination device 13 based on the position information of the departure point, the waypoint, and the arrival point designated by the user is generated as a route passing through the departure point, the waypoint, and the arrival point, and passing over the movable area 122 on the map information.

In FIG. 13B, reference numeral 123 denotes a plurality of pieces of position information on the route information. The system control device 10 that acquires the route information 120 generates the position information 123 disposed at prescribed intervals, on the route information 120.

The position information 123 can be each represented by latitude/longitude/height, and the position information 123 is referred to as position point cloud data in Embodiment 1. Then, the system control device 10 transmits the position information 123 (latitude/longitude/height of each point) to the conversion information storage device 14 piece by piece and converts the position information 123 into the unique identifier.

In FIG. 13C, reference numeral 124 denotes position space information obtained by converting the position information 123 into the unique identifier piece by piece and expressing a space range specified by the unique identifier by a square frame. The position space information 124 is obtained by converting the position information into the unique identifier. With this, the route expressed by the route information 120 is converted into and expressed as the successive position space information 124.

Note that information regarding the classification of the object that is present in or capable of entering the range of the space and the time limit is connected with each piece of position space information 124. The successive position space information 124 is referred to as the format route information in Embodiment 1.

Returning to FIG. 9, a continuation of the processing that is executed by the autonomous moving body control system will be described. Subsequent to Step S214, in Step S215, the system control device 10 downloads the space information connected with each unique identifier of the format route information from the conversion information storage device 14.

Then, in Step S216, the system control device 10 converts the space information into a format capable of being reflected in the three-dimensional map of the cyberspace of the autonomous moving body 12 to create information (hereinafter, referred to as a cost map) indicating positions of a plurality of objects (obstacles) in a prescribed space. The cost map may be initially created in relation to the spaces of the entire route of the format route information or may be created by a method that creates a cost map in such a form to be segmented by a given area and sequentially updates the cost map.

Next, in Step S217, the system control device 10 stores the format route information and the cost map in connection with a unique identification number (unique identifier) assigned to the autonomous moving body 12.

The autonomous moving body 12 monitors (polls) the unique identification number of the autonomous moving body 12 at a prescribed time interval via the network, and in Step S218, downloads the connected cost map. In Step S219, the autonomous moving body 12 reflects the latitude/longitude information of each unique identifier of the format route information as the route information in the three-dimensional map of the cyberspace created by the autonomous moving body 12.

Next, in Step S220, the autonomous moving body 12 reflects the cost map as obstacle information on the route in the three-dimensional map of the cyberspace. If the cost map is created in such a form to be segmented at given intervals, after the autonomous moving body 12 moves through an area where the cost map is created, a cost map of a next area is downloaded to update the cost map.

In Step S221, the autonomous moving body 12 moves along the route information while avoiding an object (obstacle) input by the cost map. That is, the autonomous moving body 12 performs movement control based on the cost map.

In this case, in Step S222, the autonomous moving body 12 moves while performing object detection, and moves while updating the cost map using object detection information if there is a difference from the cost map. In Step S223, the autonomous moving body 12 transmits difference information from the cost map to the system control device 10 along with the corresponding unique identifier.

In Step S224 of FIG. 10, the system control device 10 that acquires the unique identifier and the difference information from the cost map transmits the space information to the conversion information storage device 14, and in Step S225, the conversion information storage device 14 updates the space information of the unique identifier.

Here, the content of the space information to be updated does not reflect the difference information from the cost map as it is, and is transmitted to the conversion information storage device 14 after being abstracted by the system control device 10. Details of the abstraction will be described below.

In Step S226, the autonomous moving body 12 that is moving based on the format route information transmits the unique identifier connected with the space through which the autonomous moving body 12 currently passes, to the system control device 10 each time the autonomous moving body passes through the divided space in connection with the unique identifier.

Moreover, during the polling, connection with the unique identification number of the autonomous moving body 12 may be made. The system control device 10 ascertain the current position of the autonomous moving body 12 on the format route information based on the unique identifier information of the space received from the autonomous moving body 12.

With the repetition of Step S226, the system control device 10 can ascertain where the autonomous moving body 12 is present currently, in the format route information. The system control device 10 may stop holding the unique identifier of the space through which the autonomous moving body 12 has passed, and accordingly, a holding data quantity of the format route information can be reduced.

In Step S227, the system control device 10 creates the confirmation screen 50 and the map display screen 60 described with reference to FIGS. 2 and 3 based on the ascertained current position information of the autonomous moving body 12, and displays the confirmation screen 50 and the map display screen 60 on the display screen of the WEB page. Each time the unique identifier indicating the current position is transmitted from the autonomous moving body 12 to the system control device 10, the system control device 10 updates the confirmation screen 50 and the map display screen 60.

On the other hand, the sensor node 15 stores detection information of a detection range in Step S228 of FIG. 8, abstracts the detection information in Step S229, and transmits the abstracted detection information as the space information to the conversion information storage device 14 in Step S230. The abstraction is information indicating, for example, whether or not an object is present of whether or not there is a change from a state in which an object is present, and is not detailed information regarding an object.

The detailed information regarding an object is stored in the memory of the sensor node. Then, in Step S231, conversion information storage device 14 stores the space information, which is the abstracted detection information, in connection with the unique identifier of the position corresponding to the space information. With this, the space information is stored in one unique identifier in the format database.

If an external system different from the sensor node 15 utilizes the space information, the external system acquires the detection information in the sensor node 15 by way of the conversion information storage device 14 based on the space information in the conversion information storage device 14 and utilizes the detection information. In this case, the conversion information storage device 14 also has a function of linking communication standards of the external system and the sensor node 15.

The storage of the space information as described above is performed not only in the sensor node 15 but also among a plurality of devices. With this, the conversion information storage device 14 has a function of linking data of a plurality of devices with a comparatively small data amount. In Steps S215 and S216 of FIG. 9, if the system control device 10 requires detailed object information in creating the cost map, detailed information may be downloaded and used from an external system that stores detailed detection information of the space information.

Here, it is assumed that the sensor node 15 updates the space information on the route of the format route information of the autonomous moving body 12. In this case, the sensor node 15 acquires the detection information in Step S232 of FIG. 10, generates the abstracted space information in Step S233, and transmits the abstracted space information to the conversion information storage device 14 in Step S234. In Step S235, the conversion information storage device 14 stores the space information in the format database 14-4.

The system control device 10 confirms change in the space information in the format route information to be managed at a prescribed time interval, and downloads space information in Step S236 if there is change. Then, in Step S237, the autonomous moving body 12 updates the cost map connected with the assigned unique identification number.

In Step S238, the autonomous moving body 12 recognizes the update of the cost map by polling and reflects in the three-dimensional map of the cyberspace created by the autonomous moving body 12.

As described above, the space information shared by a plurality of devices is utilized, so that the autonomous moving body 12 can recognize change on the route unrecognizable by the autonomous moving body 12 in advance and cope with the change. In a case where the series of systems is executed, and the autonomous moving body 12 arrives at the arrival point in Step S239, the autonomous moving body 12 transmits the unique identifier in Step S240.

With this, the system control device 10 that recognizes the unique identifier displays arrival display on the user interface 11 in Step S241, and ends the application. According to Embodiment 1, it is possible to provide the format of the digital architecture and the autonomous moving body control system using the same in such a manner as above.

As described with reference to FIGS. 11A, 11B, and 12, information (space information) regarding the classification of the object that is present in or capable of entering the range of the space 100 and the time limit is stored in the format database 14-4 in time series from past to future. The space information is updated based on information input from an external sensor or the like connected to the conversion information storage device 14 in a communicable manner, and is shared by other external systems connectable to the conversion information storage device 14.

One of the pieces of space information is the classification information of the object in the space. The classification information of the object in the space herein is, for example, information that can be acquired from the map information such as a roadway, a sidewalk, or a motorway in a road. Information regarding a running direction of a mobility in a roadway or traffic regulations can also be defined similarly as classification information. In addition, classification information can also be defined in the space itself as described below.

As above, the cooperative operation of the conversion information storage device 14, the system control device 10 that controls the autonomous moving body 12, and the like has been described with reference to FIG. 4. Note that the conversion information storage device 14 can be connected to a system control device that manages information regarding roads or a system control device that manages information regarding sections other than roads, in addition to the system control device 10.

That is, as described above, the system control device 10 can transmit the position point cloud data that refers to the position information 123 of FIG. 13B, to the conversion information storage device 14. Similarly, the system control device that manages information regarding roads or the system control device that manages information regarding sections other than roads can also transmit corresponding data to the conversion information storage device 14.

The corresponding data is information regarding position point cloud data that is managed by the system control device that manages information regarding roads or the system control device that manages information regarding sections other than roads. Each point of the position point cloud data is hereinafter referred to as a position point.

After transmission, data is stored in connection with the unique identifier of the format database 14-4, and information is appropriately updated, information of the real world at present is accurately reflected in the conversion information storage device 14, and trouble with the movement of the autonomous moving body 12 is prevented.

In Embodiment 1, the update interval of the space information is different depending on a kind of an object present in the space. That is, in a case where the kind of the object present in the space is a moving body, the update interval is shorter than in a case where the kind of the object present in the space is not a moving body. In a case where the kind of the object present in the space is a road, the update interval is shorter than in a case where the kind of the object present in the space is a section.

In a case where a plurality of objects are present in the space, an update interval of space information regarding each object is different depending on the kind (for example, a moving body, a road, or a section) of each object. Then, space information regarding a state of each of a plurality of objects present in the space and time is formatted and stored in association with the unique identifier. Accordingly, it is possible to reduce a load for updating the space information.

### Embodiment 2

The transmission of the route of the autonomous moving body 12 to the conversion information storage device 14 by way of the user interface 11 has been described through Steps S201 to 212 with reference to FIG. 8. In Embodiment 2, in an environment in which a plurality of autonomous moving bodies are controlled, a method for storing a route of each autonomous moving body in the conversion information storage device 14 will be described using a configuration in which another autonomous moving body control system is connected to the conversion information storage device 14.

FIG. 14 is a functional block diagram illustrating connection of a conversion information storage device, a system control device, a second system control device, and the like according to Embodiment 2. In FIG. 14, to control a second autonomous moving body 141 different from the autonomous moving body 12, a second system control device 142 different from the system control device 10, and the like are added with respect to the configuration of FIG. 4.

The system control device 10, the user interface 11, the autonomous moving body 12, the route determination device 13, the conversion information storage device 14, and the sensor node 15 are the same as those illustrated in FIG. 4.

A second user interface 140 has a function equivalent to the user interface 11, but is a device that is operated by a second user and is different from the user interface 11. The second system control device 142 has a function equivalent to the system control device 10, and is a device that controls the second autonomous moving body 141 according to an input of position information from the second user interface 140 and is different from the system control device 10.

The second autonomous moving body 141 has a function equivalent to the autonomous moving body 12, and is a moving body that moves under the control of the second system control device 142 and is different from the autonomous moving body 12. A second route determination device 143 has a function equivalent to the route determination device 13, and is a device that generates the route of the second autonomous moving body 141 and is different from the route determination device 13.

The second system control device 142, the second user interface 140, the second autonomous moving body 141, and the second route determination device 143 are connected by a network as illustrated in FIG. 14. Then, the second system control device 142 is connected to the conversion information storage device 14 by the network. For this reason, a generated scheduled route of the second autonomous moving body 141 input from the second user interface 140 can be transmitted to the conversion information storage device 14.

That is, in Embodiment 2, the conversion information storage device 14 serving as a formatting unit can format and store the movement route information of each of a plurality of moving bodies in association with the unique identifier. The conversion information storage device 14 formats and stores, as the movement route information, the unique identifier in association with identification information of each moving body and a scheduled passage time of each moving body.

In a case where a plurality of system control devices are present in addition to the second system control device 142, a configuration in which the system control device 10 is connected to a plurality of system control devices including the second system control device 142 and is further connected to the conversion information storage device 14 is also considered.

However, in such a configuration, the network becomes complicated. In Embodiment 2, to prevent the network from being complicated, the system control device 10 is connected to the conversion information storage device 14, and the second system control device 142 is connected to the conversion information storage device 14.

Then, the system control device 10 performs communication with a plurality of system control devices including the second system control device 142 via the conversion information storage device 14, so that the network is prevented from being complicated. However, in a special situation described below, the system control device 10 and the second system control device 142 can also be connected using a direct communication network 144.

The autonomous moving body 12 and the second autonomous moving body 141 can also be connected using an inter-moving body network 2034. Similarly to the system of FIG. 4, each of the second user interface 140, the second system control device 142, the second route determination device 143, and the second autonomous moving body 141 are connected to the Internet 16.

The second system control device 142, the second autonomous moving body 141, the second route determination device 143, and the second user interface 140 configure an autonomous moving body control system that is independently connected to the conversion information storage device 14 separately from 10 to 13 of FIG. 4. Such an autonomous moving body control system is referred to as “another autonomous moving body control system”.

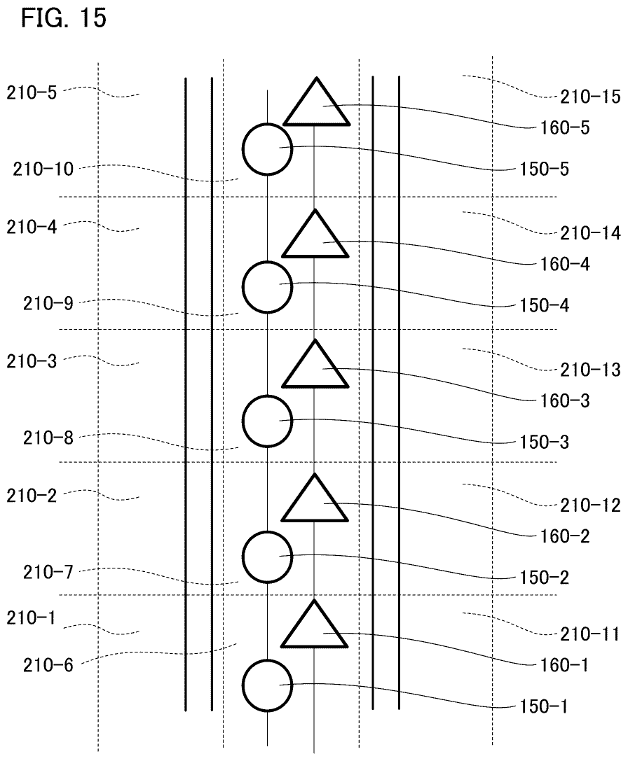

FIG. 15 is a diagram illustrating a route of the autonomous moving body 12 and a route of the second autonomous moving body 141. Here, autonomous moving body routes 150-1 to 150-5 that are a scheduled route of the autonomous moving body 12 are transmitted from the system control device 10 to the conversion information storage device 14. Second autonomous moving body routes 160-1 to 160-5 that are a scheduled route of the second autonomous moving body 141 are transmitted from the second system control device 142 to the conversion information storage device 14.

Position space information 210-1 to 210-15 are position space information that is stored in the format database 14-4 and is expressed by a square frame (a broken-line frame) specified by the unique identifier described with reference to FIG. 13C. The position space information 210-1 to 210-5 and 210-11 to 210-15 are position space information which is not a road and through which the autonomous moving body 12 and the second autonomous moving body 141 cannot move.

The position space information 210-6 to 210-10 are position space information through which the autonomous moving body 12 and the second autonomous moving body 141 can move. The autonomous moving body routes 150-1 to 150-5 are position point cloud data that refers to position information, in which the autonomous moving body 12 is scheduled to be present at each time of future time t1 to future time t5, generated by the system control device 10. It is assumed that time elapses in an order of t1, t2, t3, t4, and t5.

That is, the autonomous moving body 12 is scheduled to be present on the autonomous moving body routes 150-1 to 150-5 at time t1 to time t5, respectively.

The system control device 10 transmits the autonomous moving body routes 150-1 to 150-5, which are future routes, from the system control device 10 to the conversion information storage device 14, and the transmitted autonomous moving body routes 150-1 to 150-5 are converted into the unique identifiers by the conversion information storage device 14.

Along with the conversion into the unique identifiers, the unique identifiers are stored in connection with information that the autonomous moving body 12 (the identification information of the autonomous moving body 12) is present at each future time of each unique identifier of the format database 14-4.

That is, the conversion information storage device 14 serving as a formatting unit formats and stores, as the movement route information, the unique identifier in association with the identification information of the moving body and the scheduled passage time of the moving body.

Hereinafter, converting each piece of position information at each time of the autonomous moving body route into the unique identifier and associating and storing the unique identifier in the format database 14-4 is referred to as storing the autonomous moving body route in the format database 14-4.

The second autonomous moving body routes 160-1 to 160-5 are position point cloud data that refers to position information which generated by the second system control device 142 and in which the second autonomous moving body 141 is scheduled to be present at each time of time t1 to time t5, which are future times. That is, the second autonomous moving body 141 is scheduled to be present on the second autonomous moving body routes 160-1 to 160-5 at time t1 to time 5, respectively.

The second system control device 142 transmits the second autonomous moving body routes 160-1 to 160-5, which are future routes, from the second system control device 142 to the conversion information storage device 14, and the transmitted second autonomous moving body route 160 is stored in the conversion information storage device 14.

That is, the conversion information storage device 14 serving as a formatting unit formats and stores, as second autonomous moving body route information, the unique identification information in association with identification information of the second autonomous moving body 141 and a scheduled passage time of the second autonomous moving body 141.

In the present embodiment, a plurality of routes (information regarding a route on which a moving body is present) can be stored in the format database 14-4 at a certain position at a certain future time. That is, a scheduled route of another moving body can be stored at the same time in one unique identifier corresponding to each space. If a certain future time and a current time are close, contact is likely to occur between the moving bodies. An avoidance method will be described below.

The conversion information storage device 14 can receive a plurality of routes including third autonomous moving body routes and fourth autonomous moving body routes similarly, in addition to the autonomous moving body routes 150-1 to 150-5 and the second autonomous moving body routes 160-1 to 160-5, and can store a plurality of routes in the format database 14-4.

In the above description, an example where the autonomous moving body route 150 or the second autonomous moving body route 160 is as illustrated in FIG. 15, and information that the moving body is scheduled to be present in the position space expressed by a square frame (frame indicated by broken line) specified by adjacent unique identifiers is stored in connection with the unique identifier has been described.

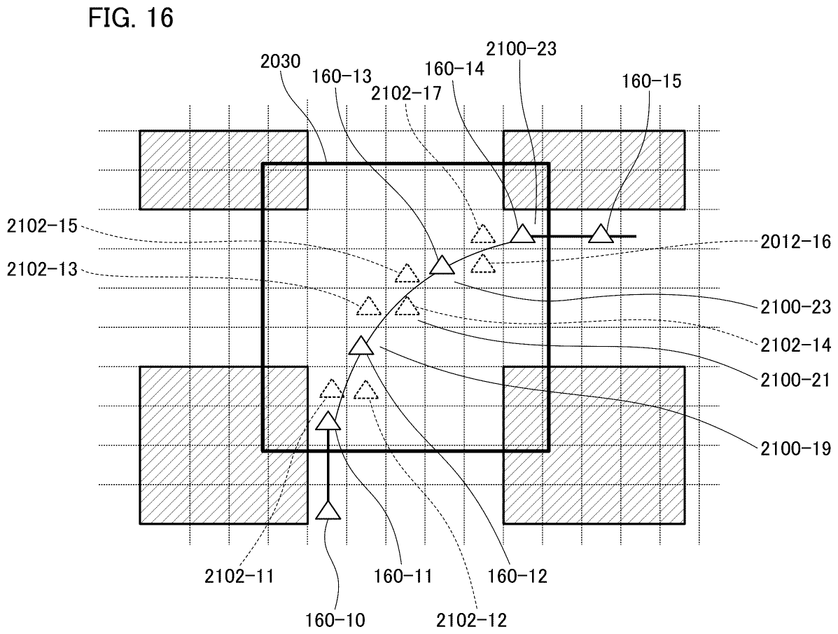

However, to reduce the capacity of the format database 14-4 of the conversion information storage device 14, information that the moving body is scheduled to be present in a position space expressed by a square frame (frame indicated by broken line) specified by every other unique identifier or every few unique identifiers may be stored in connection with the unique identifiers. This processing will be described with reference to FIG. 16.

FIG. 16 is a diagram illustrating an example where the second autonomous moving body route 160 is stored in the position space specified by every other unique identifier. That is, FIG. 16 illustrates an example where the second autonomous moving body route 160 is stored in a position space expressed by a square frame (frame indicated by broken line) specified by roughly every other unique identifier.

In FIG. 16, each of the second autonomous moving body routes 160-10 to 160-15 indicates that the second autonomous moving body 141 is scheduled to be present in the position space expressed by the square frame (frame indicated by broken line) specified by the unique identifier.

It is assumed that time elapses in an order of time t10, t11, t12, . . . , and t23. Then, it is assumed that the second autonomous moving body 141 is scheduled to be present in an order of the second autonomous moving body routes 160-10, 160-11, 160-12, 160-13, 160-14, and 160-15 at time t10, t12, t15, t19, t22, and t24, respectively.

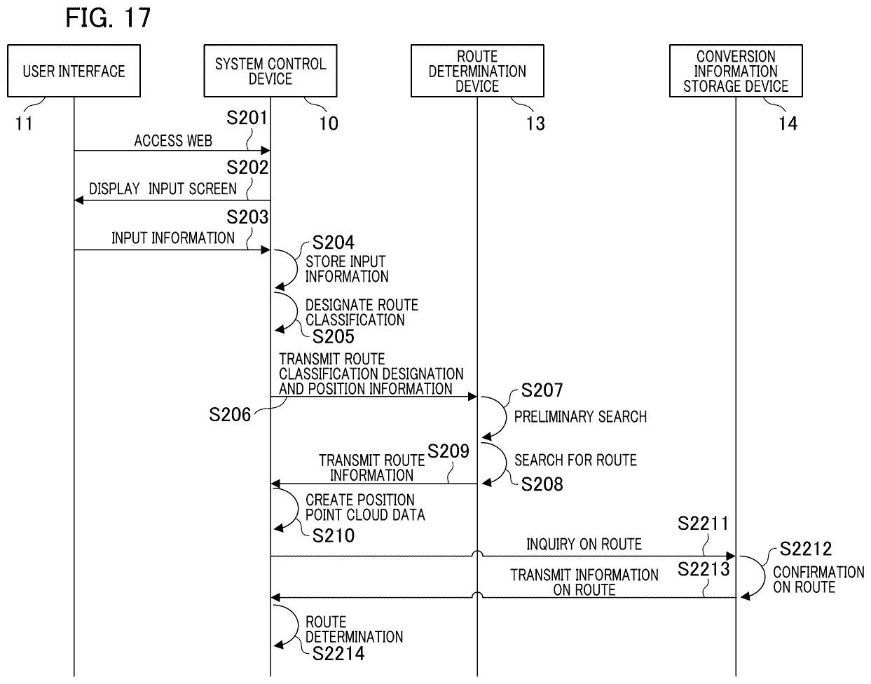

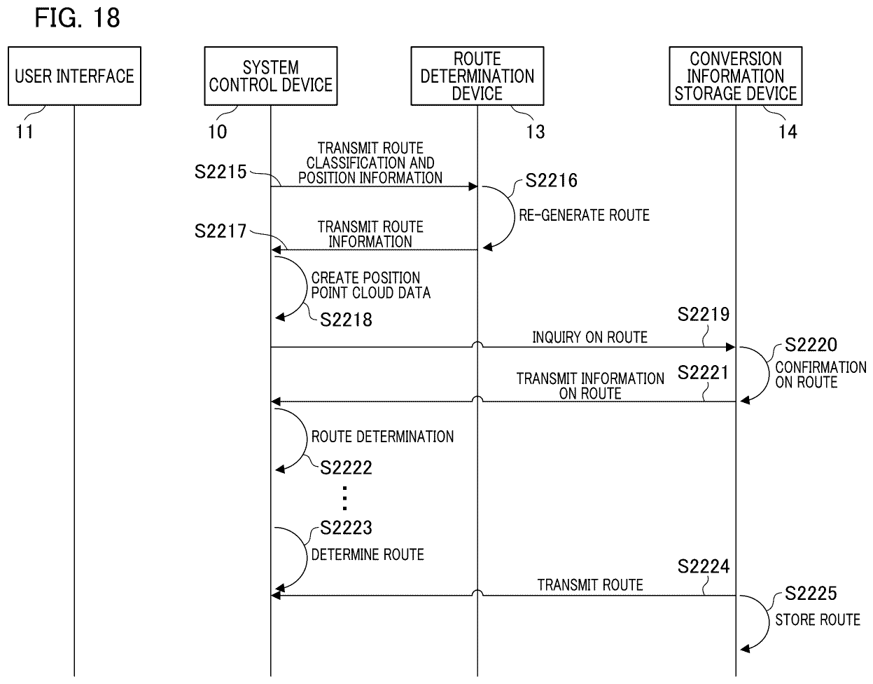

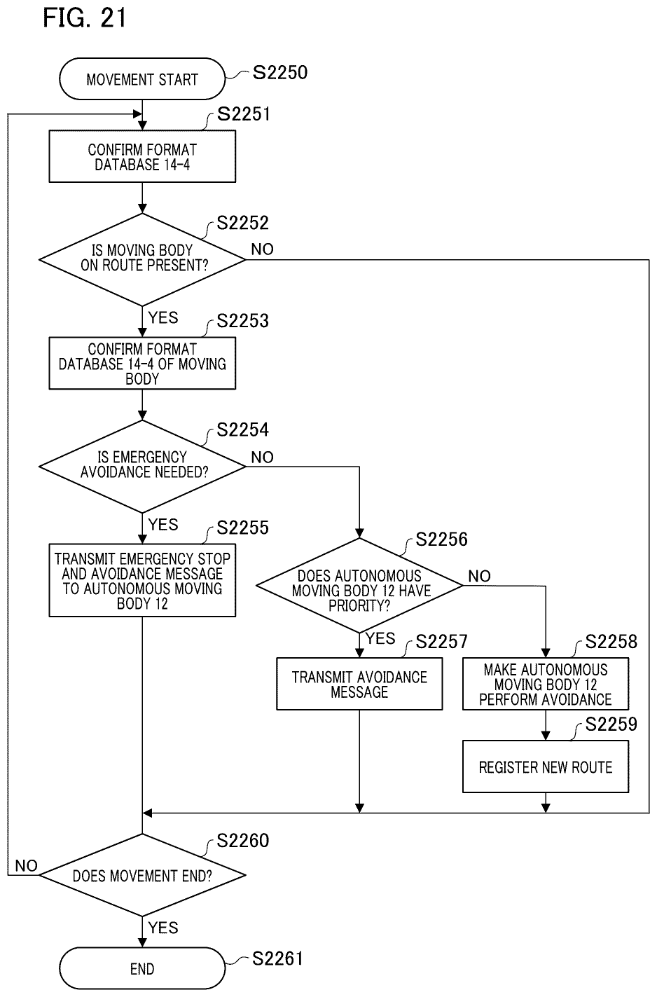

However, if the route information is stored in the position spaces expressed by the square frame (frame indicated by broken line) specified by every other unique identifier or every few unique identifiers, a problem as described below occurs. For example, for the purpose of processing illustrated in FIGS. 17 and 18 or processing illustrated in FIG. 21 described below, it is assumed that the system control device 10 performs an inquiry about whether or not there is a moving body that is present in position space information 2100-21 of time t17, to the conversion information storage device 14.

Note that information that another moving body is present is not stored in the unique identifier corresponding to the position space information 2100-21 of time t17 stored in the format database 14-4 of the conversion information storage device 14.

On the other hand, information that the second autonomous moving body 141 is present in position space information 2100-19 at time t15 and is present in position space information 2100-23 at time t19 is stored in the format database 14-4. For this reason, the second autonomous moving body 141 is highly likely to be present in the position space information 2100-21 at time t17.

That is, the second autonomous moving body 141 is highly likely to be present in the position space information 2100-21 at time t17. However, there is a problem in that, as a result of the inquiry to the format database 14-4, the system control device 10 determines that the second autonomous moving body 141 is not present in the position space information 2100-21 at time t17.

Accordingly, the system control device 10 performs an inquiry about whether or not another moving body is present in a position space in the vicinity of the position space information 2100-21 at any time before and after time t17, to the format database 14-4 of the conversion information storage device 14.

For example, an inquiry about information regarding the presence of a moving body in a plurality of position spaces inside a confirmation range 2030 represented by a solid-line square frame in a period of time of time t12 to time t22 centered on time t17 is performed. That is, the system control device 10 inquires the format database 14-4 about information regarding the presence of a moving body stored in connection with the unique identifier of each position space inside the confirmation range 2030.

Then, the system control device 10 acquires information regarding the second autonomous moving body routes 160-11 to 160-14 stored inside the confirmation range 2030 and information regarding the speed or the moving direction of the second autonomous moving body 141 stored in connection with the second autonomous moving body routes 160-11 to 160-14.

The system control device 10 creates second autonomous moving body estimated routes 2102-11 to 2102-17 from these pieces of information. The second autonomous moving body estimated routes 2102-11 to 2102-17 are estimated presence positions of the second autonomous moving body 141 estimated by the system control device 10 between the second autonomous moving body routes 160-11 to 160-14.

Through such processing, the system control device 10 can estimate that the second autonomous moving body 141 is on the second autonomous moving body estimated routes 2102-11, 2102-12, and 2102-13 at time t13, t14, and t16, respectively. The system control device 10 can estimate that the second autonomous moving body 141 is on the second autonomous moving body estimated routes 2102-14, 2102-15, 2102-16, and 2102-17 at time t17, t18, t20, and t21, respectively.

With this, even if information that the second autonomous moving body is scheduled to be present in the position space expressed by the square frame (frame indicated by broken line) specified by every other unique identifier or every few unique identifiers is stored in connection with the unique identifier, it is possible to accurately estimate the presence of the second autonomous moving body 141. In addition, this processing may be used in processing illustrated in FIGS. 17 and 18 or processing illustrated in FIG. 21 described below to estimate the presence of another moving body.

In this way, in the present embodiment, in a case where the movement route information is formatted and stored in association with every other unique identifier or every few unique identifiers discretely, information between discrete movement route information is estimated and used.

In the above-described processing, the confirmation range 2030 uses 7×7 position spaces center on the position space information 2100-21, and the second autonomous moving body estimated routes 2102-11 to 2102-17 are created.

Note that a set of 8×8 (for a solid, 8×8×8), 16×16 (for a solid, 16×16×16), or more position spaces may be set as a master position space by the format database 14-4. In this case, instead of the confirmation range 2030, the master position space is searched for by Morton order or the like, and the second autonomous moving body estimated routes 2102-11 to 2102-17 may be created using the master position space.

For the purpose of reducing the capacity of communication between the second system control device 142 and the conversion information storage device 14, or the like, the above-described processing may be executed by the conversion information storage device 14, instead of the system control device 10. Then, information that the second autonomous moving body 141 is presented in the estimated position space may be stored in the format database 14-4.

In a case where the second autonomous moving body routes 160-11 to 160-14 are stored in position spaces expressed by square frames (frames indicated by broken line) specified by unique identifiers at a distance of a prescribed value or more, estimation is difficult. Even if estimation is carried out, the second autonomous moving body 141 is highly likely to be not present in the estimated position space.

For this reason, in a case where the second autonomous moving body routes 160-11 to 160-14 are stored in the position spaces expressed by the square frames (frames indicated by broken lines) specified by the unique identifiers at a distance of the prescribed value or more, it is desirable that the above-described processing is not executed.

As described above, a method for determining the route of the autonomous moving body 12 in consideration of a plurality of scheduled routes in an environment in which each of a plurality of other autonomous moving body control systems stores a scheduled route in the conversion information storage device 14 will be described.

FIG. 17 is a sequence diagram for determining the route of the autonomous moving body 12 in a case where routes of a plurality of autonomous moving bodies are stored in the format database 14-4 of the conversion information storage device 14, and FIG. 18 is a continuation of the sequence diagram of FIG. 17.

The operations in steps of the sequences of FIGS. 17 and 18 are performed by the computer in the control units of 10, 11, 13, and 14 executing the computer program stored in the memory. The processing of Step S201 to Step S210 is the same as the processing illustrated in FIG. 7, and description thereof will not be repeated.

In Step S210, if the processing of creating the position point cloud data ends, in Step S2211, the system control device 10 performs an inquiry about whether or not another moving body is present on an autonomous moving body route which is a scheduled route of the autonomous moving body 12, to the conversion information storage device 14.

Specifically, the system control device 10 performs an inquiry about the information stored in the format database 14-4 of the conversion information storage device 14 in connection with the unique identifier at a time when the autonomous moving body 12 is presented in each piece of position information of the autonomous moving body route and within a given time before and after the time.

The conversion information storage device 14 that receives the inquiry acquires the corresponding information stored in the format database 14-4 in connection with the unique identifier and performs confirmation on the route, which means confirmation whether any moving body exists or not on the route, in Step S2212.

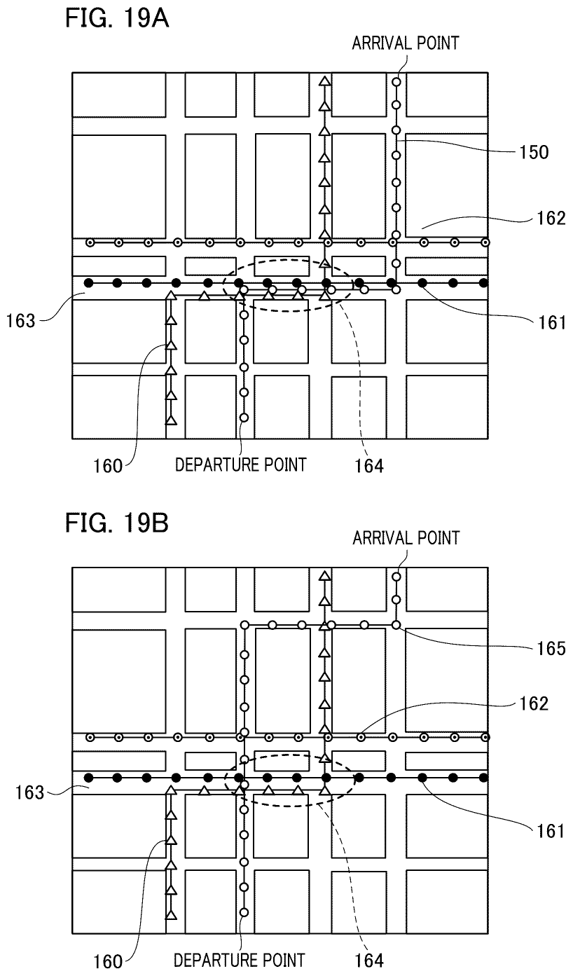

Then, in Step S2213, the conversion information storage device 14 transmits information on the route, which means information regarding whether any moving body exists or not on the route. Specifically, information stored in the format database 14-4 in connection with the unique identifier at time when the autonomous moving body 12 is present in each piece of position information of the autonomous moving body route and within the given time before and after the time is transmitted to the system control device 10. The system control device 10 that receives information performs route determination by a method illustrated in FIG. 19 in Step S2214.

FIGS. 19A and 19B are image diagrams illustrating a state in which routes of a plurality of autonomous moving bodies are stored in the format database 14-4, displayed in map information. FIG. 19A is a diagram illustrating an autonomous moving body route 150 that is an initially generated route of the autonomous moving body 12. FIG. 19B is a diagram illustrating an autonomous moving body route 165 generated by changing the autonomous moving body route 150.

For convenience, while the autonomous moving body route 150 is also illustrated in FIG. 19, it is assumed that, in the state illustrated in FIG. 19, the routes stored in the format database 14-4 are a second autonomous moving body route 160, a third autonomous moving body route 161, and a fourth autonomous moving body route 162.

The second autonomous moving body route 160 is a route of the second autonomous moving body 141 generated by a system including the second system control device 142, the second user interface 140, the second autonomous moving body 141, the second route determination device 143 and stored in the conversion information storage device 14.

Similarly, the third autonomous moving body route 161 is a route of a third autonomous moving body generated by a system including a third system control device, a third user interface, a third autonomous moving body, and a third route determination device (not illustrated) and stored in the conversion information storage device 14.

Similarly, the fourth autonomous moving body route 162 is a route of a fourth autonomous moving body generated by a system including a fourth system control device, a fourth user interface, a fourth autonomous moving body, and a fourth route determination device (not illustrated) and stored in the conversion information storage device 14. A crowded area 164 indicated by a broken line indicates a section where the second autonomous moving body route 160 and the third autonomous moving body route 161 overlap, and a lot of time is required for passage.

As illustrated in FIG. 19A, in information transmitted from the conversion information storage device 14 in the processing of Step S2213, the second autonomous moving body route 160 and the third autonomous moving body route 161 overlap in the crowded area 164 on the autonomous moving body route 150. Accordingly, the second autonomous moving body 141 and the third autonomous moving body are present within a given time before and after the autonomous moving body 12 is present.

For this reason, for example, the speed needs to be controlled to be decreased such that contact does not occur. Alternatively, if a plurality of moving bodies cannot pass simultaneously with respect to a road width, traffic control is required such that the moving bodies pass in order. Thus, the time to reach the arrival point is likely to be delayed.

Returning to FIG. 17, if another moving body is present on the autonomous moving body route 150, a required passage time that is expected by the autonomous moving body route 150 exceeds an upper limit, and a delay of an arrival time is considered. Accordingly, in the processing of Step S2214, determination is made to execute processing of re-generating a route.

That is, determination is made that a route should be re-generated, based on information regarding a road width of a road acquired in Step S2213 and stored in connection with the unique identifier and what distance a section where several other moving bodies are present within a given time before and after on the road occurs.

It is assumed that road 163 of FIG. 19A has only such a road width that just one autonomous moving body passes. For this reason, if a crowded section where three or more moving bodies including the autonomous moving body 12 passes through the road 163 occurs over a prescribed distance or more, the system control device 10 determines that the required passage time expected by the autonomous moving body route 150 exceeds the upper limit.

If a road width is wider than the road 163, a threshold regarding the number of moving bodies is further increased, and a threshold of a section where a number of moving bodies equal to or greater than the threshold are crowded is extended. If a road width is narrower than the road 163, on the contrary, the threshold regarding the number of moving bodies is further decreased, and the threshold of the section where a number of moving bodies equal to or greater than the threshold are crowded is reduced.

In the processing of Step S2214, in addition to the crowded area 164 where three or more moving bodies including the autonomous moving body route 150 are present, in a case where an obstacle is present, a case where a matter that interferes with movement occurs, or the like, a route may be re-generated.

Even in a case where a required passage time expected by the autonomous moving body route 165 exceeds an upper limit, a route may be re-generated. For example, the above-described matter includes crossing shut-off where a road is shut off for a prescribed time or more, road construction that interferes with passage, road damage, road flooding, and snow coverage at a prescribed height or more on a road.

In Step S2214, if traffic obstruction or the like caused by congestion or the above-described obstacle or matter such as crossing shut-off for a long time or construction for a long time is determined, not only a route may be newly generated, but also a warning unit that performs a warning to the user may be provided. Then, a warning step of performing a warning to the user by voice, CG, or the like with the warning unit may be executed.

Then, to re-generate a route, in Step S2215 of FIG. 18, the system control device 10 transmits the position information of the departure point and the arrival point, information for avoiding the crowded area 164, and information for re-generating a route based on such information to the route determination device 13. The avoidance of the crowded area 164 includes not only simply making a detour around the crowded area 164, but also shifting a time of passing through the crowded area 164, that is, passing through the crowded area 164 at a time when crowding does not occur.

The route determination device 13 that receives information for re-generating a route searches for a route that is a next most optimum route (less movement time) of the autonomous moving body route 150 and makes a detour around the crowded area 164, and re-generates a route in Step S2216.

Then, in Step S2217, the route determination device 13 transmits the re-generated route to the system control device 10. In Step S2218, the system control device 10 converts the received re-generated route into position point cloud data to create position point cloud data.

In Step S2219, similarly to Step S2211, the system control device 10 performs an inquiry about whether or not another moving body is present on the re-generated route, to the conversion information storage device 14. The conversion information storage device 14 that receives the inquiry confirms again whether or not another moving body is present on each unique identifier on the re-generated route, based on data stored in the format database 14-4 in Step S2220.

Thereafter, in Step S2221, the conversion information storage device 14 transmits information regarding whether or not another moving body is present on the re-generated route, to the system control device 10.

Here, description will be provided with reference to FIG. 19B. The autonomous moving body route 165 is the route re-generated in Step S2216 and is the position point cloud data converted in Step S2218. As illustrated in FIG. 19B, the autonomous moving body route 165 makes a detour around the crowded area 164 where three or more moving bodies are present.

There is no new crowded area on the autonomous moving body route 165. Accordingly, the autonomous moving body route 165 rather than the autonomous moving body route 150 can be said to be a safer route since a lot of time is not required, and a risk of contact in the crowded area is reduced.

In the description of the present embodiment, spaces (voxels) specified by the unique identifiers composing the format route information in creating format route information described below from the position point cloud data are linked together with no gap. That is, thinning/interpolation of position point cloud data is performed.

However, the present invention is not limited thereto, and at least an interval between the point information composing the position point cloud data is equal to or greater than an interval between the starting point (reference point) positions of the divided spaces, and the movement route can be set such that the divided spaces do not overlap.

As the interval between the position point cloud data is more narrowed, the movement route can be designated in more detail. Meanwhile, the data amount of the entire movement route increases. If the interval between the position point cloud data increases, the movement route cannot be designated in detail, but the data amount of the entire movement route can be suppressed.

That is, the interval between the position point cloud data can be appropriately adjusted in conformity with conditions such as an indication granularity of the movement route to the autonomous moving body 12 and the amount of data to be handled. The interval between the position point cloud data can be changed partially and a more optimum route can be set.

Returning to the description of FIG. 18, in Step S2222, similarly to Step S2214, the system control device 10 performs determination on the autonomous moving body route 165. In Step S2223, the system control device 10 determines that there is no crowded area where two or more other moving bodies are present, on the autonomous moving body route 165, and finally determines the autonomous moving body route 165 as the route.

Through the processing of Step S2222, if a crowded area is found again on the autonomous moving body route 165, Step S2215 to Step S2222 are repeated. Even if the processing of Step S2215 to Step S2222 is repeated ten times, if a route that does not pass through a crowded area is not found, a route in which the number of moving bodies present in the crowded area is smallest or a section passing through a crowded area is shortest is selected and determined.

Next, in Step S2224, the system control device 10 transmits, for example, the determined autonomous moving body route 165 to the conversion information storage device 14. In Step S2225, the conversion information storage device 14 stores the received autonomous moving body route 165 in the format database 14-4. Through the above processing, the system control device 10 can determine a route for allowing the autonomous moving body 12 to efficiently move in consideration of the routes of a plurality of autonomous moving bodies.

The autonomous moving body route 165 determined through the above-described processing is an optimum route when the autonomous moving body 12 starts to move at a certain time. If the start of the movement is delayed due to the situation of the user, the autonomous moving body route 165 may not be an optimum route.

Note that it is not efficient to execute the processing of Step S2211 to Step S2224 illustrated in FIGS. 17 and 18 similarly due to a processing load. Accordingly, processing of re-determining a route with efficiency while executing the processing of Step S2211 to Step S2224 illustrated in FIGS. 17 and 18 in a case where the movement start is delayed will be described.

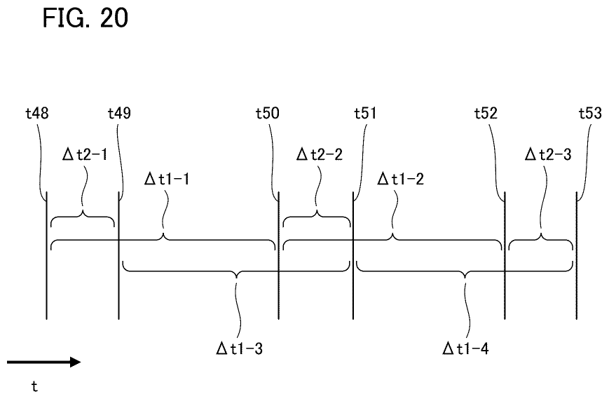

FIG. 20 is a diagram illustrating a flow of times of a certain position point on the autonomous moving body route 165, and illustrates a flow of times before and after a scheduled time when the autonomous moving body 12 is present at a certain position point on the scheduled autonomous moving body route 165, in Step S2211 illustrated in FIG. 17. In FIG. 20, it is assumed that time elapses from left to right. The scheduled time when the autonomous moving body 12 is present at the certain position point is denoted as time t50.

In the processing of Step S2211 illustrated in FIG. 17, the system control device 10 performs an inquiry about whether another moving body is present on an autonomous moving body route which is a scheduled route of the autonomous moving body 12, to the conversion information storage device 14. Specifically, information stored in the format database 14-4 in connection with the unique identifier at a time when the autonomous moving body 12 is present in each piece of position information of the autonomous moving body route and within a prescribed time before and after the time is requested.

In this processing, it is assumed that the request for information stored in the format database 14-4 in connection with the unique identifier at time t50 and within the prescribed time before and after the time has been performed at the certain position point.

That is, it is assumed that information regarding a certain position point for time Δt1-1 of time t48 to time t50 and for time Δt1-2 of time t50 to time t52 at a certain position point illustrated in FIG. 20 has been acquired. Here, it is assumed that the start of the movement is delayed due to the situation of the user, and a time when the autonomous moving body 12 is present at a certain position point is delayed for time Δt2-2 from time t50 and is deviated to time t51.

Through the above-described processing, information until time t52 has been acquired, and thus, in the processing of Step S2211 that is newly executed due to the delay, an inquiry about information for time Δt2-3 of time t52 to time t53 is performed. Here, it is assumed that time Δt2-2 and time Δt2-3 have the same time interval. That is, it is possible to efficiently execute the processing of Step S2211 by acquiring only information for the delay of the time when the autonomous moving body 12 is present at a certain point.

It is also assumed that time Δt1-1 and time Δt1-3 have the same time interval, time Δt1-2 and time Δt1-4 have the same time interval, and time Δt2-1 and time Δt2-2 have the same time interval. Then, the processing of Step S2211 to Step S2213 is executed with information for time Δt1-3 and time Δt1-4 before and after time t51 when a moving body is scheduled to be present at a certain point.

In the above description, although description has been provided using a certain position point on the autonomous moving body route 165 as an example, it is assumed that similar processing is executed in relation to all position points of the autonomous moving body route 165. Through the above processing, even in a case where the start of the movement is delayed due to the situation of the user, it is possible to re-determine a route with efficiency.

In this way, in the present embodiment, if the scheduled movement start time by the movement route information and an actual movement start time are deviated for a prescribed time or more, the movement route information of at least one moving body is changed.

If the start of the movement is slightly delayed, and a delay time at any position point on the autonomous moving body route 165 is equal to or less than a given time, change for the time is small. Thus, the processing of Step S2211 to Step S2224 may not be executed again.

It is assumed that the movement start is significantly delayed, and for example, time Δt2-2 illustrated in FIG. 20 is the same as time Δt1-2 or more. If such deviation of the position point on the autonomous moving body route 165 occurs, efficiency is not much changed. Thus, instead of the efficient processing of Step S2211 to Step S2224, the normal processing of Step S2211 to Step S2224 may be executed.

Next, route change in a case where an immediate future route of the autonomous moving body 12 and an immediate route of another autonomous moving body overlap and contact may occur while the autonomous moving body 12 is moving along the route determined through the above-described processing will be described.

FIG. 21 is a flowchart illustrating processing in a case where an immediate route overlaps an immediate route of another autonomous moving body. The operations in steps of the sequence of FIG. 21 are performed by the computer in the control unit of the system control device 10 executing the computer program stored in the memory.

As illustrated in FIG. 21, in Step S2250, if the autonomous moving body 12 starts to move, the process starts. In Step S2251, the system control device 10 that performs a control instruction to the autonomous moving body 12 confirms information in the space on the route in the format database 14-4 of the conversion information storage device 14 for five seconds ahead from the present.

Specifically, during traveling, the system control device 10 confirms about whether or not information that another moving body is present is associated with the unique identifier at each position at each time on the route of the autonomous moving body 12 for five seconds ahead from the present. In the present embodiment, while the above-described given time is five seconds, the given time may be suitably changed according to the situation.

As a result of the confirmation to the format database 14-4, in Step S2252, if determination is made that another moving body is present on an immediate future route, the process proceeds to Step S2253, and if another moving body is not present, the process proceeds to Step S2260.

In Step S2253, the system control device 10 confirms information of another moving body present on the route of the autonomous moving body 12, stored in the format database 14-4. That is, the system control device 10 reads out information such as speed and moving direction stored in the format database 14-4 in connection with the unique identifier, the position of the autonomous moving body 12 and the position of another moving body stored in the format database 14-4, and the like. Then, the system control device 10 calculates a distance between the autonomous moving body 12 and another moving body based on these pieces of data.

In Step S2254, determination is made whether or not the autonomous moving body 12 needs to perform emergency avoidance. In Step S2254, if the system control device 10 determines that emergency avoidance is needed, the process proceeds to Step S2255, and if determination is made that emergency avoidance is not needed, the process proceeds to Step S2256.

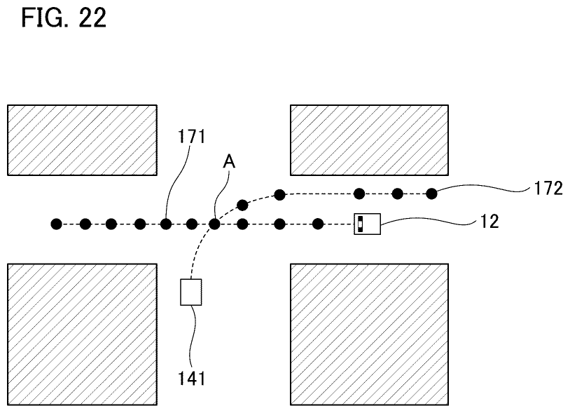

Here, FIG. 22 is a diagram illustrating a state in which determination is made that emergency avoidance is needed. FIG. 22 illustrates a state in which the autonomous moving body 12 is likely to come into contact with the second autonomous moving body 141 during movement, and the system control device 10 determines that emergency avoidance is needed.

In FIG. 22, reference numeral 171 denotes an immediate route, and indicates a route on which the autonomous moving body 12 is present in the future a given time ahead from the present. Reference numeral 172 denotes a second immediate route, and indicates a route on which the second autonomous moving body 141 is present in the future a given time ahead from the present. A position A indicates a position where the autonomous moving body 12 and the second autonomous moving body 141 are present simultaneously at time A. That is, FIG. 22 illustrates that contact is likely to occur at the position A.

Returning to the description of FIG. 21, in Step S2254, if determination is made that emergency avoidance is needed as illustrated in FIG. 22, in Step S2255, the system control device 10 transmits an emergency avoidance message to the autonomous moving body 12. That is, the system control device 10 performs an instruction of emergency stop or slow movement.

Then, the system control device 10 transmits a message for prompting to take an avoidance behavior such as movement stop or slow movement of the moving body to the second system control device 142 that controls the second autonomous moving body 141 present on the route, by way of the conversion information storage device 14. With this, the movement route information is temporarily changed. In Step S2254, if contact is likely to occur, a warning unit that performs a warning by voice, CG, or the like may be provided.

The above-described emergency avoidance is not limited to another moving body such as an autonomous moving body, and for a falling rock, dash of a small animal, or a flying object, similar processing may be performed to perform an instruction of emergency stop or slow movement of the autonomous moving body 12 as long as the above-described condition is satisfied.

For an obstacle with almost no movement, construction, a crossing, or a structure such as an electric pole, a building, or a bridge, similar processing may be performed to perform an instruction of emergency stop or slow movement of the autonomous moving body 12 as long as the above-described condition is satisfied.

On the other hand, in Step S2254, if determination is made that emergency avoidance is not needed, in Step S2256, the system control device 10 determines whether or not the autonomous moving body 12 has priority over another moving body present on the immediate route.

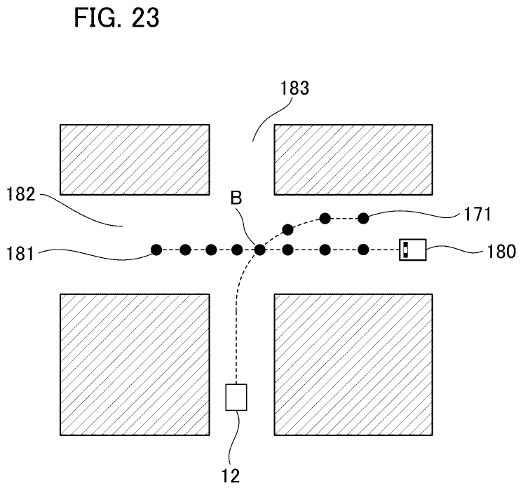

Here, FIG. 23 is a diagram illustrating a state of crossing a route of a moving body having a high priority level. FIG. 23 illustrates that an immediate route 171 which is a future route of the autonomous moving body 12 a given time ahead and an emergency moving body immediate route 181 which an immediate future route of an emergency moving body 180 cross at a position B at the same time.

The emergency moving body 180 is, for example, an emergency vehicle such as a fire truck, a patrol car, or an ambulance, and is an emergency vehicle that is traveling in emergency such as turning on a warning light and sounding a siren.

In regard to the emergency moving body 180, similarly to the second autonomous moving body 141 illustrated in FIG. 14, it is assumed that a system is configured with an emergency moving body system control device (not illustrated), an emergency moving body user interface (not illustrated), the emergency moving body 180, and an emergency moving body route determination device (not illustrated). It is also assumed that the emergency moving body system control device is connected to the conversion information storage device 14.

In the state illustrated in FIG. 23, information that the autonomous moving body 12 and the emergency moving body 180 are present at the same position B at the same time is stored in the format database 14-4, and contact is likely to occur. A road 182 is a road that has a comparatively wide width, and has a high priority level as described below. On the other hand, a road 183 is a road that has a comparatively narrow width, and has a low priority level as described below.

Returning to the description of FIG. 21, in Step S2256, to determine which of the autonomous moving body 12 and the emergency moving body 180 has priority, the system control device 10 performs an inquiry about the priority levels of the autonomous moving body 12 and the emergency moving body 180 at the position B of FIG. 23 to the conversion information storage device 14.

The priority level of a moving body present at the position at the time can be stored in connection with the unique identifier of the format database 14-4 of the conversion information storage device 14. In the present embodiment, for example, the priority level can be stored in six levels, 0 is a lowest priority level, and 5 is a highest priority level. In the present embodiment, when an emergency vehicle such as a patrol car or a fire truck is traveling in emergency such as turning on a warning light and sounding a siren, the priority level of 3 or more is given.

It is assumed that the priority level can be changed in a range of 3 to 5 according to emergency during emergency traveling of the emergency vehicle. During traveling of a normal moving body and an emergency vehicle in non-emergency, the priority level of 0 to 2 is given. While the priority level is basically 0, a public moving body such as a bus that is moving as public transportation may have a priority level of 1 to 2. In a case where a moving body has a problem with movement due to a breakdown or the like, or the like, the priority level may be increased.

In Step S2256, in response to the inquiry from the system control device 10 to the conversion information storage device 14, the conversion information storage device 14 performs a reply. That is, the conversion information storage device 14 transmits information regarding the priority levels of the autonomous moving body 12 and the emergency moving body 180 at the position B at the same time stored in the format database 14-4 to the system control device 10.

The system control device 10 that receives information regarding the priority levels compares the priority levels of the autonomous moving body 12 and the emergency moving body 180 at the position B at the same time. The autonomous moving body 12 has a priority level of 0 as a normal vehicle that is normally traveling, and the emergency moving body 180 has a priority level of 3 as an emergency vehicle that is traveling in emergency in the state of FIG. 12. For this reason, the system control device 10 determines that the emergency moving body 180 has priority.

If the priority levels are the same, the priority levels of the road 182 having a wide width and the road 183 having a narrow width are compared, and the road having a wide width is given priority. The routes of the autonomous moving body route 150 and the emergency moving body immediate route 181 are compared in terms of a straight route or a right/left turn route, and a straight route is given priority.

In Step S2256, if the system control device 10 determines that the autonomous moving body 12 has priority, the process proceeds to Step S2257, and if determination is not made that the autonomous moving body 12 has priority, the process proceeds to Step S2258.

In Step S2256, if the system control device 10 determines that the autonomous moving body 12 has priority, in Step S2257, the system control device 10 transmits a message for prompting to take an avoidance behavior to a system control device that controls another moving body present on the route. The message of the avoidance behavior is transmitted from the system control device 10 to the system control device that controls another moving body, by way of the conversion information storage device 14.

In Step S2256, if the system control device 10 determines that the autonomous moving body 12 has no priority, in Step S2258, the route determination device 13 generates an avoidance route for avoidance according to an instruction of the system control device 10. Then, the system control device 10 transmits an instruction for making the autonomous moving body 12 travel along the avoidance route, and makes the autonomous moving body 12 move along the avoidance route.

Here, Step S2258 functions as a changing step (changing unit) of changing the movement route information of at least one moving body having a low priority level based on the priority levels of a plurality of moving bodies if contact is likely to occur based on the movement route information of each moving body.

If another moving body present on the immediate route is traveling in emergency as an emergency vehicle having a priority level of 3 or more, the system control device 10 instructs the autonomous moving body 12 to perform the following avoidance operation.

That is, the route determination device 13 creates a route for making the autonomous moving body 12 slowly move in a state of being shifted to a left side for left-hand traffic and stopping the autonomous moving body 12 as occasions demand, according to an instruction of the system control device 10, and the system control device 10 instructs the autonomous moving body 12 to move along the route. Note that, if there is an avoidance behavior rule during traveling of an emergency vehicle in emergency of each region, an instruction of movement along a route conforming to the avoidance behavior rule is performed.

Then, in Step S2259, the system control device 10 transmits and registers (updates) a new route of the autonomous moving body 12 to the conversion information storage device 14. Step S2260 is processing of determining whether or not the movement of the autonomous moving body 12 ends.

In Step S2260, if the movement of the autonomous moving body 12 does not end, the processing of Step S2251 to Step S2259 is repeated. If the movement of the autonomous moving body 12 ends, the flow of FIG. 21 for changing the route along which the autonomous moving body 12 is moving ends.

In Step S2254 of FIG. 21, if the emergency avoidance is needed, in Step S2255, the autonomous moving body 12 is brought into emergency stop. Note that, in a case where direct communication by the direct communication network 144 illustrated in FIG. 14 is facilitated such as a case where the system control device 10 and the system control device that controls another moving body present on the route use the same communication protocol, the moving body may be made to perform the avoidance operation using direct communication. The direct communication network 144 may be implemented by wired connection or wireless communication.

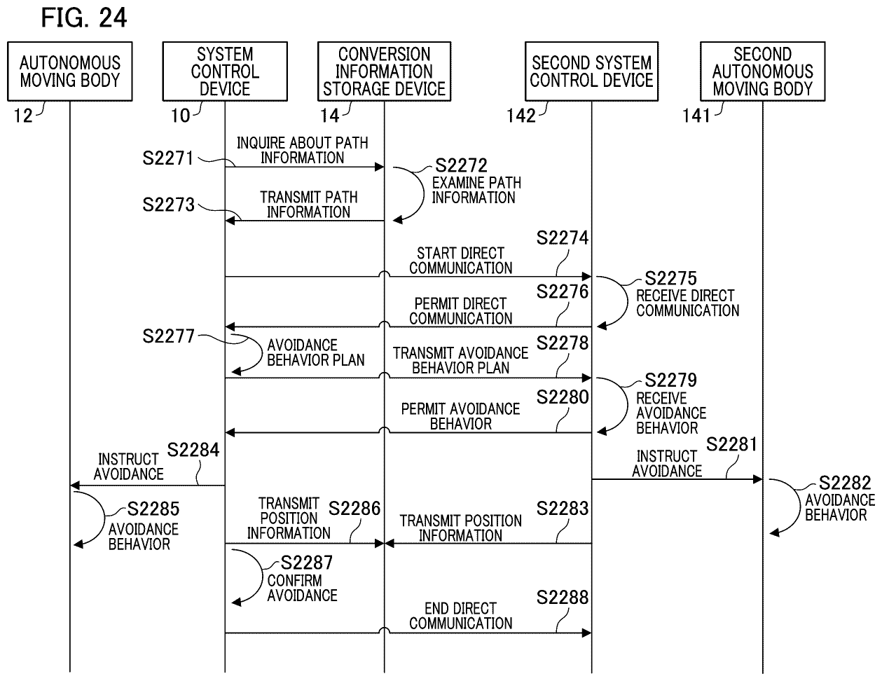

Next, the avoidance operation using direct communication will be described. FIG. 24 is a sequence diagram illustrating processing for performing emergency avoidance. FIG. 24 illustrates the sequence in a case where the system control device 10 and the second system control device 142 perform direct communication to perform emergency avoidance if the autonomous moving body 12 needs emergency avoidance with respect to the second autonomous moving body 141. The operations in steps of the sequence of FIG. 24 are performed by the computer in the control units of 10, 12, 14, 141, and 142 executing the computer program stored in the memory.

In the situation as in FIG. 22, if the system control device 10 determines that emergency avoidance is needed, in Step S2271 of FIG. 24, the system control device 10 performs an inquiry about information of a path (communication path) of the second autonomous moving body 141 to the conversion information storage device 14. Here, the path information is information in which a method or a path for direct communication with the second system control device 142 is described.

In the format database 14-4, information that the second autonomous moving body 141 associated with the unique identifier at the position A of FIG. 22 is present at time ta is stored, and the path information for direct communication with the second system control device 142 is stored. Accordingly, in Step S2271, the system control device 10 acquires the path information from the format database 14-4.

In Step S2272, the conversion information storage device 14 reads out the path information of the second system control device 142 that controls the second autonomous moving body 141 present at the position A at time ta, from the format database 14-4. Then, in Step S2273, the conversion information storage device 14 transmits the path information to the system control device 10.

In Step S2274, the system control device 10 that receives the path information sends a signal to start direct communication to the second system control device 142 based on the path information such that the autonomous moving body 12 and the second autonomous moving body 141 perform the avoidance operation.

In Step S2275, the second system control device 142 that receives the signal to start direct communication prepares for a reply. Then, in Step S2276, the second system control device 142 replies a signal to permit direct communication to the system control device 10.

In Step S2277, the system control device 10 that receives the signal creates an avoidance behavior plan of the autonomous moving body 12 and the second autonomous moving body 141 with the route determination device 13. The avoidance behavior plan includes information regarding a route for allowing the second autonomous moving body 141 to perform avoidance and a route for allowing the autonomous moving body 12 to perform avoidance.

Then, in Step S2278, the system control device 10 transmits the avoidance behavior plan to the second system control device 142, and in Step S2279, the second system control device 142 receives the avoidance behavior plan. In Step S2280, the second system control device 142 that receives the avoidance behavior plan transmits a permission signal of avoidance behavior plan.

It is desirable that the route for avoidance of the second autonomous moving body 141 included in the avoidance behavior plan is information regarding the route specified by the unique identifier to be confirmed by the second system control device 142 performing communication with the conversion information storage device 14.

In Step S2281, the second system control device 142 transmits an instruction of movement along the route for avoidance of the second autonomous moving body 141 described in the avoidance behavior plan to the second autonomous moving body 141. In Step S2282, the second autonomous moving body 141 that receives the instruction of movement along the route for avoidance moves along the route to start an avoidance behavior.

On the other hand, in Step S2284, the system control device 10 that receives the permission signal of the avoidance behavior plan in Step S2280 also transmits an instruction of movement along the route for avoidance of the autonomous moving body 12 according to the avoidance behavior plan to the autonomous moving body 12. With this, in Step S2285, the autonomous moving body 12 moves along the route to start an avoidance behavior.

Thereafter, in Step S2283, the second system control device 142 transmits the new route of the second autonomous moving body 141 to the conversion information storage device 14. In Step S2286, the system control device 10 transmits the new route of the autonomous moving body 12 to the conversion information storage device 14.

Then, in Step S2287, the system control device 10 confirms whether or not contact between the autonomous moving body 12 and the second autonomous moving body 141 can be avoided. That is, the system control device 10 confirms whether or not the second autonomous moving body 141 is present at each point at each time on the route of the autonomous moving body 12 stored in the format database 14-4 within a given time from the present. If the contact cannot be avoided, the processing of Step S2277 to Step S2287 is repeated.

If avoidance is confirmed, in Step S2288, the system control device 10 transmits a signal to end direct communication to the second system control device 142, and emergency avoidance ends. Through the above processing, the avoidance behavior in a case where the immediate future route of the autonomous moving body 12 and the immediate future route of another autonomous moving body overlap is performed.

In the above description, description that the system control device 10 performs the avoidance behavior using the second system control device 142 and the direct communication network 144 has been provided. Note that an avoidance behavior using direct communication between the autonomous moving body 12 and the second autonomous moving body 141 by the inter-moving body network 2034 illustrated in FIG. 14 may be performed.

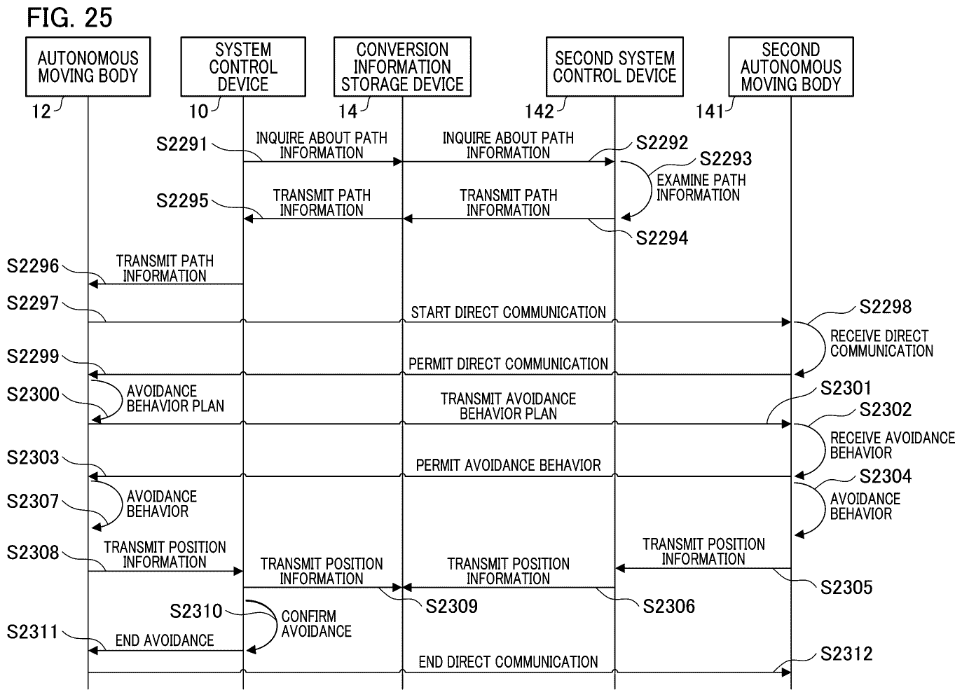

FIG. 25 is a sequence diagram in a case where the autonomous moving body 12 and the second autonomous moving body 141 perform direct communication to perform emergency avoidance. Referring to FIG. 25, a sequence for performing an avoidance behavior using direct communication between the autonomous moving body 12 and the second autonomous moving body 141 by the inter-moving body network 2034 will be described. It is desirable that the inter-moving body network 2034 is communication implemented by wireless communication in terms of communication between the moving bodies.

The operations in steps of the sequence of FIG. 25 are performed by the computer in the control units of 10, 12, 14, 141, and 142 executing the computer program stored in the memory.

If the system control device 10 or the detection unit 12-1 of the autonomous moving body 12 determines that the autonomous moving body 12 needs emergency avoidance in the situation as illustrated in FIG. 22, the following processing is executed. That is, in Step S2291 illustrated in FIG. 25, the system control device 10 performs inquiry about the path information (communication path and the like) of the second autonomous moving body 141 to the conversion information storage device 14.

Then, if contact is likely to occur between the autonomous moving body 12 and the second autonomous moving body 141, the movement route information of at least one moving body is changed by performing direct communication between at least two moving bodies.

Specifically, in information that the second autonomous moving body 141 is present, stored in the format database 14-4 in connection with the unique identifier corresponding to the position A at time A, the path information of the second system control device 142 is stored along with the information. An inquiry about the path information of the second autonomous moving body 141 to the second system control device 142 by way of the conversion information storage device 14 is performed using the path information of the second system control device 142.

In Step S2292, the conversion information storage device 14 that receives the inquiry about the path information for direct communication with the second autonomous moving body 141 transfers the inquiry to the second system control device 142.

In Step S2293, the second system control device 142 that receives the inquiry acquires the path information for direct communication with the second autonomous moving body 141. In Step S2294, the second system control device 142 transmits the acquired path information for direct communication with the second autonomous moving body 141 to the conversion information storage device 14.

In Step S2295, the conversion information storage device 14 that receives the path information for direct communication with the second autonomous moving body 141 transfers the path information to the system control device 10. In Step S2296, the system control device 10 further transfers the path information to the autonomous moving body 12.

In Step S2297, the autonomous moving body 12 that receives the path information of the second autonomous moving body 141 transmits a signal to start direct communication to the second autonomous moving body 141 based on the path information of the second autonomous moving body 141 to perform an avoidance behavior in cooperation with the second autonomous moving body 141.

In Step S2298, the second autonomous moving body 141 that receives the signal to start direct communication prepares for direct communication. Then, in Step S2299, the second autonomous moving body 141 sends a signal to permit direct communication to the autonomous moving body 12.

In Step S2300, the autonomous moving body 12 that receives the signal creates an avoidance behavior plan of the autonomous moving body 12 and the second autonomous moving body 141. Here, the avoidance behavior plan includes information regarding a route for avoidance of the second autonomous moving body 141 generated by the autonomous moving body 12 and a route for avoidance of the autonomous moving body 12 generated by the autonomous moving body 12.

Here, Step S2300 functions as a changing step (changing unit) of changing the movement route information of at least one moving body by performing communication between at least two moving bodies if contact is likely to occur.

Then, in Step S2301, the autonomous moving body 12 transmits the avoidance behavior plan to the second autonomous moving body 141. It is desirable that the route for avoidance of the second autonomous moving body 141 included in the avoidance behavior plan is information regarding the route specified by the unique identifier to be confirmed by the second autonomous moving body 141 performing communication with the conversion information storage device 14 by way of the second system control device 142.

In Step S2302, the second autonomous moving body 141 receives the avoidance behavior plan. In Step S2303, the second autonomous moving body 141 that receives the avoidance behavior plan transmits a permission signal of the avoidance behavior plan.

Then, in Step S2304, the second autonomous moving body 141 starts to move along the route for avoidance described in the avoidance behavior plan. Thereafter, in Step S2305, the second autonomous moving body 141 transmits the route for avoidance of the second autonomous moving body 141 to the second system control device 142.

In Step S2306, the second system control device 142 that receives the route for avoidance of the second autonomous moving body 141 transfers the route for avoidance of the second autonomous moving body 141 to the conversion information storage device 14.

On the other hand, in Step S2307, the autonomous moving body 12 that receives the permission signal of the avoidance behavior plan in Step S2303 also starts to move along the route for avoidance of the autonomous moving body 12 according to the avoidance behavior plan.

Thereafter, in Step S2308, the autonomous moving body 12 transmits the route for avoidance to the autonomous moving body 12 to the system control device 10. In Step S2309, the system control device 10 that receives the route for avoidance of the autonomous moving body 12 transfers the route for avoidance of the autonomous moving body 12 to the conversion information storage device 14.

Then, in Step S2310, the system control device 10 confirms whether or not contact between the autonomous moving body 12 and the second autonomous moving body 141 can be avoided. That is, the system control device 10 confirms whether or not the second autonomous moving body 141 is present at each point at each time on the route of the autonomous moving body 12 stored in the format database 14-4 within a given time from the present.

If contact cannot be avoided, the processing of Steps S2300 to S2310 is repeated. The confirmation about whether or not contact can be avoided may be performed by the autonomous moving body 12 itself using the detection unit 12-1 of the autonomous moving body 12.

In Step S2311, the system control device 10 that can confirm avoidance transmits a confirmation signal of avoidance to the autonomous moving body 12. In Step S2312, the autonomous moving body 12 that receives the confirmation signal of avoidance transmits a signal to end direct communication, and emergency avoidance ends.

As described above, according to the above-described embodiment, in the autonomous moving body control system using the space information of the three-dimensional space defined by latitude/longitude/height, it is possible to avoid contact with another moving body and to improve safety.

Through the processing illustrated in FIG. 21, if a time for which a moving body is present at each position point of the route determined through the processing illustrated in FIGS. 17 and 18 is delayed for a given time or more, the processing illustrated in FIGS. 17 and 18 may be executed again, and a route may be determined again.

In the above-described embodiment, an example where the control system is applied to the autonomous moving body has been described. Note that the moving body of the present embodiment is not limited to an autonomous moving body such as an automatic guided vehicle (AGV) or an autonomous mobile robot (AMR). Any device may be applied as long the device is, for example, a moving device that moves such as an automobile, a train, a ship, an airplane, a robot, or a drone.

A part of the control system of the present embodiment may or may not be mounted in the moving body. The present embodiment can be applied to a case where the moving body is remotely controlled. The present embodiments can also be applied to a moving body that is not a completely autonomous moving body, for example, a moving body having a driving assistance function.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing system through a network or various storage media. Then, a computer (or a CPU, an MPU, or the like) of the information processing system may be configured to read and execute the program. In such a case, the program and the storage medium storing the program configure the present invention.

The present application claims the benefits of Japanese Patent Application No. 2022-014166, filed on Feb. 1, 2022, Japanese Patent Application No. 2022-109019, filed on Jul. 6, 2022, and Japanese Patent Application No. 2022-200058, filed on Dec. 15, 2022, all of which are hereby incorporated by reference in their entireties.

What is claimed is:

1. An information processing system comprising:
at least one processor or circuit configured to function as:
a formatting unit configured to give a unique identifier to a space in three dimensions defined by a prescribed criterion, and format and store space information regarding a state of an object present in the space and time in association with the unique identifier,
wherein the formatting unit formats and stores movement route information of each of a plurality of moving bodies in association with the unique identifier.

2. The information processing system according to claim 1, wherein the at least one processor or circuit is further configured to function as,
a changing unit configured to change the movement route information of at least one moving body based on the movement route information of each of the plurality of moving bodies.

3. The information processing system according to claim 1, wherein the at least one processor or circuit is further configured to function as,
a changing unit configured to change the movement route information of at least one moving body if determination is made that contact is likely to occur based on the movement route information of each of the plurality of moving bodies.

4. The information processing system according to claim 2,
wherein the change includes stopping of movement or slowing down of movement of the moving body.

5. The information processing system according to claim 1, wherein the at least one processor or circuit is further configured to function as,
a warning unit configured to perform a warning if congestion or contact is likely to occur based on the movement route information of each of the plurality of moving bodies.

6. The information processing system according to claim 1,
wherein the formatting unit formats and stores, as the movement route information, the unique identifier in association with identification information of the moving body and a scheduled passage time of the moving body.

7. The information processing system according to claim 3,
wherein, if contact is likely to occur based on the movement route information of each of the plurality of moving bodies, the changing unit changes the movement route information of the moving body having a low priority level based on priority levels of the plurality of moving bodies.

8. The information processing system according to claim 1, wherein the at least one processor or circuit is further configured to function as,
a route generation unit configured to generate route information relating to the movement route of the moving body based on the space information acquired from the formatting unit and classification information of the moving body.

9. The information processing system according to claim 1,
wherein the formatting unit formats information regarding an update interval of the space information in association with the unique identifier.

10. The information processing system according to claim 9,
wherein the information regarding the update interval is different depending on a kind of an object present in the space.

11. The information processing system according to claim 10,
wherein, in a case where the classification of the object present in the space is a moving body, the information regarding the update interval is shorter than in a case where the classification of the object present in the space is not a moving body.

12. The information processing system according to claim 1,
wherein, in a case where the movement route information is formatted and stored in association with the unique identifier discretely, information for between pieces of discrete movement route information is estimated and used.

13. The information processing system according to claim 3,
wherein, in a case where contact is likely to occur, the movement route information of at least one moving body is changed by performing communication between at least two moving bodies.

14. The information processing system according to claim 1,
wherein, in a case where a scheduled movement start time in the movement route information and an actual movement start time deviate by a prescribed time or more, the movement route information of at least one moving body is changed.

15. A control method comprising:
a formatting step of giving a unique identifier to a space in three dimensions defined by a prescribed criterion, and formatting and storing space information regarding a state of an object present in the space and time in association with the unique identifier,
wherein, in the formatting step, movement route information of each of a plurality of moving bodies is formatted and stored in association with the unique identifier.

16. A non-transitory computer-readable storage medium configured to store a computer program comprising instructions for executing following processes:
a formatting of giving a unique identifier to a space in three dimensions defined by a prescribed criterion, and formatting and storing space information regarding a state of an object present in the space and time in association with the unique identifier,
wherein, in the formatting, movement route information of each of a plurality of moving bodies is formatted and stored in association with the unique identifier.
